(19) United States
(12) Patent Application Publication
(10) Pub. No.: US 2006/0024596 A1
(43) Pub. Date: Feb. 2, 2006

(54) Electrophotographic photoconductor for wet developing and image-forming apparatus for wet developing

(76) Inventors: Jun Azuma, Osaka (JP); Hideki Okada, Osaka (JP)

Correspondence Address: Arthur G. Schaier;Carmody & Torrance LLP, 50 Leavenworth Street, P.O. Box 1110, Waterbury, CT, 06721-1110, US

(21) Appl. No.: 11/170,493

(22) Filed: Jun. 29, 2005

(30) Foreign Application Priority Data
Jul. 27, 2004 (JP) 2004-218332

(51) Int. Cl. G03G 5/06

(52) U.S. Cl. 430/73; 430/56; 430/74; 399/159; 430/58.75

(57) ABSTRACT

Provided are an electrophotographic photoconductor for wet developing excellent in solvent resistance having a photoconductor improved in not only solvent resistance but also charging characteristics even after long-term usage, and an image-forming apparatus equipped with such an electrophotographic photoconductor for wet developing.

Therefore, an electrophotographic photoconductor for wet developing equipped with an organic photoconductor containing at least a binder resin, a charge-generating agent, a hole-transfer agent and an electron-transfer agent, where the amount of elution of the hole-transfer agent after 2,000-hour-immersion in paraffin solvent having a kinematic viscosity (25° C., in accordance with ASTM D455) of 1.4 to 1.8 mm²/s is 0.040 g/m² or less or the amount of elution of the electron-transfer agent after 2,000-hour-immersion in paraffin solvent having a kinematic viscosity (25° C., in accordance with ASTM D455) of 1.4 to 1.8 mm²/S is 0.12 g/m²2 or less.

### TECHNICAL FIELD

The present invention relates to an electrophotographic photoconductor for wet developing and an image-forming apparatus for wet developing, and in particular to an electrophotographic photoconductor for wet developing excellent in solvent resistance and to an image-forming apparatus for wet developing equipped with such an electrophotographic photoconductor for wet developing.

### BACKGROUND ART

Conventionally, organic photoconductors, which are made of organic photoconductor materials such as charge-transfer materials (hole-transfer agents and electron-transfer agents), charge-generating agents and binder resins, have been widely used as electrophotographic photoconductors for wet developing equipped in an image forming apparatus and so on. The organic photoconductors are advantageous in its simplicities of manufacturing processes and configurations, compared to a conventional inorganic photoconductors. In addition, there is another advantage in easy wet developing process using liquid developer.

However, the conventional electrophotographic photoconductor for wet developing has a disadvantage in that it tends to be suffered from liquid developer called “Isopar” when the photoconductors are used for an extended period of time.

Therefore, the present inventors have previously proposed an electrophotographic photoconductor for wet developing of a monolayered type, comprising a charge-developing agent, a hole-transfer agent, an electron-transfer agent and a binder resin, where the binder resin contains a polycarbonate resin having a specific repetitive structural unit to exert excellent solvent resistance (e.g., Patent Document No. 1).

In addition, the present inventors have previously proposed an electrophotographic photoconductor for wet developing of a monolayered type, comprising a charge-developing agent, a hole-transfer agent, an electron-transfer agent and a binder resin, where the hole-transfer agent contains a specific stilbene compound to exert excellent solvent resistance (e.g., Patent Document No. 2).
[Patent Document No. 1] JP-A-2002-116560 (Claims, etc.)
[Patent Document No. 2] JP-A-2001-192359 (Claims, etc.)

### DISCLOSURE OF THE INVENTION

[Problems to be Solved by the Invention]

Although each invention has focused on a hole-transfer agent containing a stilbene compound, there are, in some cases, insufficiencies with respect to its solvent resistance and charging property in long-term use in the electrophotographic photoconductor for wet developing of the described Patent Documents No. 1 and No. 2.

For solving this disadvantage, the present inventors have completed the invention by finding out the fact that charging characteristics of sensitivity's variations or repeat characteristics may be estimated and solvent resistance of the photoconductor may be improved even in a long-term use by restricting the amount of elution of a hole-transfer agent or an electron-transfer agent when it is immersed into specific paraffin solvent under certain conditions.

That is, an object of the invention is to provide an electrophotographic photoconductor for wet developing which is excellent in both solvent resistance and charging characteristics even after long-term usage, and to provide an image-forming apparatus equipped with such an electrophotographic photoconductor for wet developing.

[Means to Solve the Problems]

The invention provides an electrophotographic photoconductor for wet developing having a photoconductive layer containing a binder resin, a charge-generating agent, a hole-transfer agent and an electron-transfer agent, where the amount of elution of the hole-transfer agent after 2,000-hour-immersion in paraffin solvent having a kinematic viscosity (25° C., in accordance with ASTM D445) of 1.4 to 1.8 mm²/s is 0.040 g/m² or less, or an electrophotographic photoconductor for wet developing having a photoconductive layer containing a binder resin, a charge-generating agent, a hole-transfer agent and an electron-transfer agent, where the amount of elution of the electron-transfer agent after 2,000-hour-immersion in paraffin solvent having a kinematic viscosity (25° C., in accordance with ASTM D445) of 1.4 to 1.8 mm²/s is 0.12 g/m² or less. The invention also provides an image forming apparatus for wet developing in which such an electrophotographic photoconductor for wet developing is equipped. Using such electrophotographic photoconductor and image-forming apparatus of the invention, aforesaid problems may be solved.

[Effects of the Invention]

According to the electrophotographic photoconductor for wet developing of the invention, by limiting the amount of elution of a hole-transfer agent from a photoconductive layer in the duration of 2,000 hours, the solvent resistance, sensitivity characteristics and charging characteristics of the electrophotographic photoconductor for wet developing may be estimated in case of long-term usage such as image formation on 100,000 sheets of paper. In addition, the invention also focuses on the amount of elution of the hole-transfer agent when the hole-transfer agent are immersed into predetermined paraffin solvent under the predetermined condition, the solvent resistance of the electrophotographic photoconductor for wet developing in long-term usage may be increased, while the sensitivity characteristics and charging characteristics thereof to be precisely estimated. Alternatively, by limiting the amount of the elution of the hole-transfer agent in the duration of 200 hours, not only for 2000 hours, the solvent resistance, sensitivity characteristics and charging characteristics of the electrophotographic photoconductor for wet developing after long-term usage may be estimated in relatively short time.

According to the electrophotographic photoconductor for wet developing of the invention, by limiting the amount of elution of an electron-transfer agent from a photoconductive layer in the duration of 2,000 hours, the solvent resistance, sensitivity characteristics and charging characteristics of the electrophotographic photoconductor for wet developing may be estimated in case of long-term usage such as image formation on 100,000 sheets of paper. In addition, the invention also focuses on the amount of elution of the electron-transfer agent when the electron-transfer agent are immersed into predetermined paraffin solvent under the predetermined condition, the solvent resistance of the electrophotographic photoconductor for wet developing in long-term usage may be increased, while the sensitivity characteristics and charging characteristics thereof to be precisely estimated.

Alternatively, by limiting the amount of the elution of the electron-transfer agent in the duration of 200 hours, not only for 2000 hours, the solvent resistance, sensitivity characteristics and charging characteristics of the electrophotographic photoconductor for wet developing after long-term usage may be estimated in relatively short time.

In addition, according to the electrophotographic photoconductor for wet developing of the invention, a hole-transfer agent may be prevented from crystallization by defining the amount of addition of the hole-transfer agent within the predetermined range, and an electrophotographic photoconductor for wet developing excellent in sensitivity characteristics may be provided.

According to the electrophotographic photoconductor for wet developing of the invention, by defining the molecular weight of a hole-transfer agent within a predetermined value, only a small amount of the hole-transfer agent is eluted even after long-term immersion in hydrocarbon-based solvent used as a developer for wet developing. In addition, the electrophotographic photoconductor for wet developing may also provide excellent solvent resistance and durability because the hole-transfer agent has good compatibility with the binder resin.

According to the electrophotographic photoconductor for wet developing of the invention, by employing a hole-transfer agent having a specific structure, only a small amount of the hole-transfer agent is eluted even after long-term immersion in hydrocarbon-based solvent used as a developer for wet developing. And the electrophotographic photoconductor for wet developing may also provide excellent solvent resistance and durability because the hole-transfer agent has good compatibility with the binder resin.

In addition, according to the electrophotographic photoconductor for wet developing of the invention, by defining the amount of addition of an electron-transfer agent within a predetermined rang, the electrophotographic photoconductor for wet developing may effectively prevent the electron-transfer agent from crystallization, and also may provide excellent sensitivity characteristics.

According to the electrophotographic photoconductor for wet developing of the invention, by defining the molecular weight of an electron-transfer agent to a predetermined value, only a small amount of the electron-transfer agent as well as the hole-transfer agent is eluted even after long-term immersion in a hydrocarbon-based solvent used as a developer for wet developing. And the electrophotographic photoconductor for wet developing may also provide excellent solvent resistance and durability because the electron-transfer agent has good compatibility with the binder resin.

Furthermore, the electrophotographic photoconductor for wet developing of the invention may be designed to thereby provide an electrophotographic photoconductor that retains predetermined charging characteristics for long periods of time in spite of easiness in its configuration and production by having monolayer photoconductor.

Furthermore, according to the image-forming apparatus for wet developing of the present invention, by employing a developer that contains specific paraffin solvent as a liquid carrier, variations in solvent resistance and repeat characteristics of a photoconductor after long-term usage may be precisely estimated.

In addition, according to the image-forming apparatus for wet developing of the present invention, by defining the content of an aromatic component in a paraffin solvent used for evaluation on immersion to a predetermined amount, variations in kinematic viscosity of the paraffin solvent may be prevented, and also variations in solvent resistance, charging characteristics or repeat characteristics of a photoconductor after long-term usage may be precisely estimated.

Here, the content of the aromatic component in the paraffin solvent may be determined using a gas chromatographic method in accordance with Japanese industrial standard (JIS) K 2536.

### BRIEF DESCRIPTION OF DRAWINGS

FIGS. 1(a) to (c) are diagrams for illustrating the basic structure of a monolayer photoconductor, respectively.

FIG. 2 is a diagram showing a relationship between the viscosity average molecular weight of the binder resin and the amount of elution of the hole-transfer agent.

FIG. 3 is a diagram showing a relationship between the viscosity average molecular weight of the binder resin and variations in charged potential.

FIG. 4 is a diagram showing a relationship between the kinematic viscosity of the paraffin solvent for immersing the electrophotographic photoconductor for wet developing and the amount of elution the electron-transfer agent.

FIG. 5 is a diagram showing a relationship between the kinematic viscosity of the paraffin solvent for immersing the electrophotographic photoconductor for wet developing and the amount of elution of the hole-transfer agent.

FIG. 6 is a diagram showing a relationship between the amount of elution of the electron-transfer agent and the repeat characteristics of the electrophotographic photoconductor for wet developing.

FIG. 7 is a diagram showing a relationship between the duration of immersion of the electrophotographic photoconductor for wet developing and the amount of elution of the electron-transfer agent.

FIG. 8 is a diagram showing a relationship between the molecular weight of the electron-transfer agent and the amount of elution of the electron-transfer agent.

FIG. 9 is a diagram showing a relationship between the amount of elution of the hole-transfer agent and variations in sensitivity.

FIG. 10 is a diagram showing a relationship between the duration of immersion of the electrophotographic photoconductor for wet developing and the amount of elution of the hole-transfer agent.

FIG. 11 is a diagram for illustrating an image-forming apparatus for wet developing.

### BEST MODE FOR CARRYING OUT THE INVENTION

Hereinafter, embodiments with respect to the electrophotographic photoconductor for wet developing and the image-forming apparatus for wet developing of the present invention will be concretely described with reference to the drawings in an appropriate manner.

[First Embodiment]

A first embodiment of the invention is an electrophotographic photoconductor for wet developing having at least a binder resin, a charge-generating agent, a hole-transfer agent and an electron-transfer agent, where the amount of elution of the hole-transfer agent after 2,000-hour-immersion in paraffin solvent having a kinematic viscosity (25° C., in accordance with ASTM D445) of 1.4 to 1.8 mm²/s is 0.040 g/m² or less, or the amount of elution of the electron-transfer agent after 2,000-hour-immersion in paraffin solvent having a kinematic viscosity of 1.4to 1.8 mm²/s is 0.040 g/m² or less. Here, each of the terms “the amount of elution of the hole-transfer agent” and “the amount of elution of the electron-transfer agent” refer to as the amount thereof eluted per unit area of the electrophotographic photoconductor for wet developing.

Furthermore, there are two types of electrophotographic photoconductors for wet developing; those are monotype and laminatetype. The electrophotographic photoconductor for wet developing of the invention may apply any of these types.

However, it is preferable to construct as a monolayer type because of the following reasons. That is, in particular, it may be used for both positive and negative electrification characteristics, it may be of a simplified structure and easily produced, it may be prevented from generating coating defect at the time of forming a photoconductor layer, and it may be of few boundary surfaces between layers and the optical characteristics thereof may be improved.

1. Monolayer Photoconductor

(1) Basic Configuration

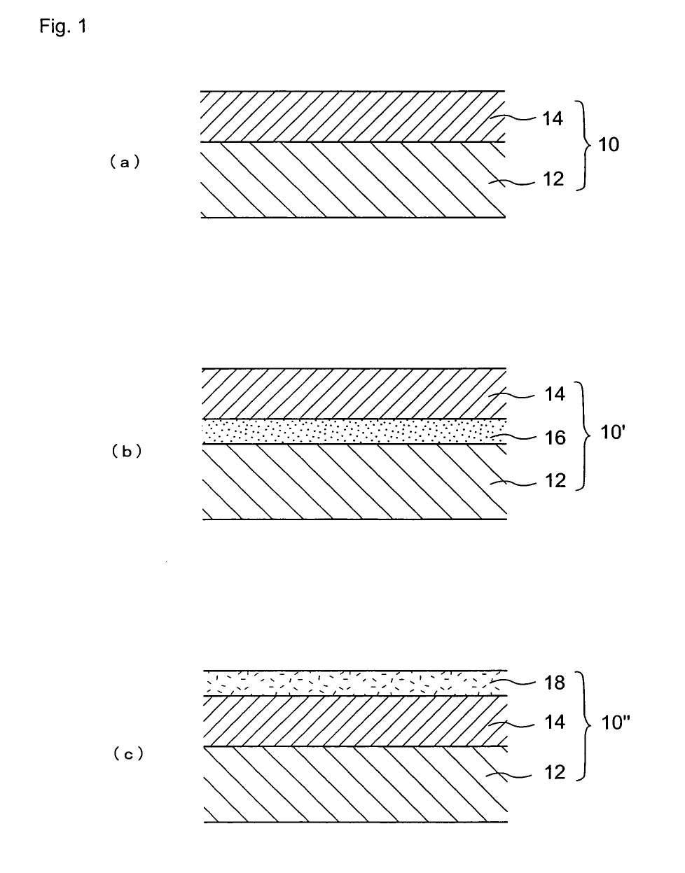

As shown in FIG. 1(a), a monolayer photoconductor 10 comprises a conductive substrate 12 and a single photoconductor layer 14 provided thereon.

The photoconductor layer 14 may be formed such that a hole-transfer agent, an electron-transfer agent, a charge-generating agent and a binder resin, and, if required, any of other additional agents such as a leveling agent, are dissolved or dispersed in appropriate solvent. The resultant coating solution is applied on the conductive substrate 12 and then dried.

The monolayer photoconductor 10 is characterized in that it is applicable to both positive and negative charging types in an individual configuration, it is simply configured in a layered structure, and it is excellent in productivity.

Furthermore, as shown in FIG. 1(b), the monolayer photoconductor 10 may be constructed as an electrophotographic photoconductor 10′ in which the photoconductor layer 14 is mounted on the conductive substrate 12 through an intermediate layer 16. Alternatively, as shown in FIG. 1(C), it may be constructed as an electrophotographic photoconductor 10′ in which a protective layer 18 may be mounted on the surface of the photoconductor layer 14.

(2) Binder Resin

(2)-1 Variety

As a binder resin for dispersing the charge-generating agent or the like, any of various resins conventionally used in photoconductors in the prior arts maybe used. For instance, a group of polycarbonate resins such as bisphenol Z type, bisphenol ZC type, bisphenol C type or bisphenol A type, a group of thermoplastic resins such as polyacrylate resins, polystyrene-butadiene copolymers, styrene-acrylonitrile copolymers, styrene-maleinic acid copolymers, acryl copolymers, styrene-acrylic acid copolymers, polyethylene resins, ethylene-vinyl acetate copolymers, chlorinated polyethylene resins, polyvinyl chloride resins, polypropylene resins, ionomer resins, vinyl chloride-vinyl acetate copolymers, alkyd resins, polyamide resins, polyurethane resins, polysulfone resins, diallyl phthalate resins, ketone resins, polyvinyl butyral resins or polyether resins, a group of cross-linkable resins such as silicone resins, epoxy resin, phenol resins, urea resin or meramine resins, and a group of photo-curing resins such as epoxy acrylate or urethane acrylate are used as the binder resins.

In addition, as a concrete example of the binder resin, a polycarbonate resin represented by the general formula (2) described below is preferably used because of the following reasons: The polycarbonate resin having such a structure will be hardly dissolved in a hydrocarbon-based solvent and show high oil repellent property. As a result, an interaction between the surface of the photoconductor layer and the hydrocarbon-based solvent becomes small and thus a change in appearance of the surface of the photoconductor layer will be small for a long period of time.

Furthermore, the alphabetical letters “b” and “d” in the general formula (2) described below represent a mole ratio between copolymer components. For example, the mole ratio is represented as 15:85 when b is 15 and d is 85. In addition, such a mole ratio may be calculated by, for example, using NMR.

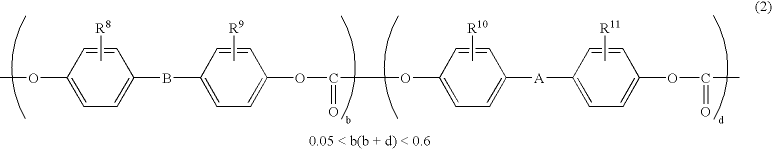

In the general formula (2), each of R⁸, R⁹, R¹⁰, and R¹¹ independently represents a hydrogen atom, a substituted or unsubstituted alkyl group having 1 to 20 carbon atoms, a substituted or unsubstituted aryl group having 6 to 30 carbon atoms. Letter A represents a single bond such as —O—, —S—, —CO—, —COO—, —(CH₂)₂—, —SO—, —SO₂—, —CR¹²R¹³—, —SiR¹²R¹³— or —SiR¹²R¹³—O— (each of R¹² and R¹³ independently represents a hydrogen atom, a substituted or unsubstituted alkyl group having 1 to 8 carbon atoms, a substituted or unsubstituted aryl group having 6 to 30 carbon atoms, a trifluoromethyl group or a cycloalylidene group in which R¹² and R¹³ are combined together to form a ring structure having 5 to 12 carbon atoms and may have an alkyl group having carbon atoms 1 to 7 as a substituted group), and letter B represents a single bond such as —O—, or —CO—.

(2)-2 Viscosity Average Molecular Weight

Furthermore, it is preferable that the viscosity average molecular weight of the binder resin is within the range of 40,000 to 80,000. This is because the use of the binder resin having such a specific molecular weight may effectively provide an electrophotographic photoconductor for wet developing having qualities of the small amount of elution of a hole-transfer agent or the like as well as excellent ozone resistance property even after long-term immersion in hydrocarbon-based solvent to be used as a wet-type developer.

In other words, the above reason is that solvent resistance may be remarkably decreased when the binder resin such as a polycarbonate resin has a viscosity average molecular weight of less than 40,000. On the other hand, when the binder resin such as a polycarbonate resin has a viscosity average molecular weight of more than 80,000, the ozone resistance property may be remarkably decreased and the photoconductive layer tends to be whitened at the time of applying a photoconductive layer.

Therefore, viscosity average molecular weight of the binder resin such as the polycarbonate resin is preferably in the range of 50,000 to 79,000, more preferably in the range of 60,000 to 78,000.

Furthermore, the viscosity average molecular weight (M) of the polycarbonate resin is determined such that the limiting viscosity [η] of the polycarbonate resin was obtained by using an Ostwald viscometer and then placed in Schnell's formula, followed by calculating the equation of [η]=1.23×10⁻⁴M^{0.83} to obtain the viscosity average molecular weight (M) of the polycarbonate resin.

Incidentally, the value of [η] may be determined from a polycarbonate resin solution obtained by dissolving a polycarbonate resin in a methylene chloride solution provided as a solvent at 20° C. such that the polycarbonate resin reaches to a concentration (C) of 6.0 g/dm³.

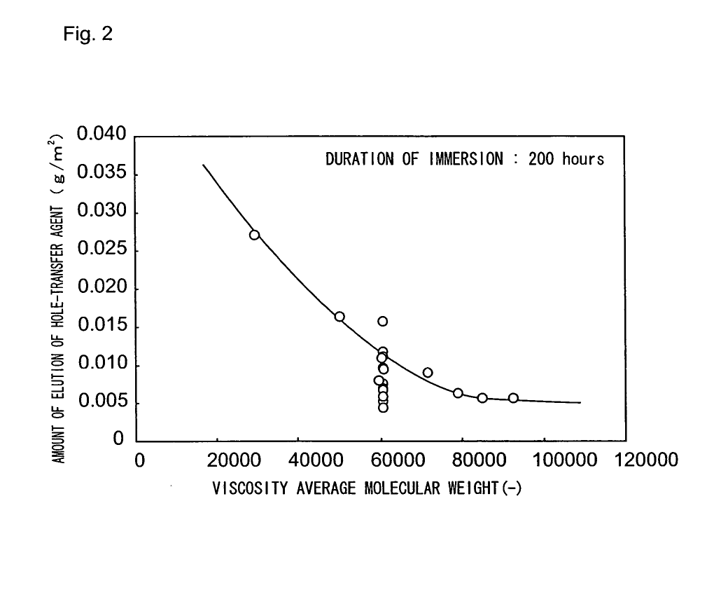

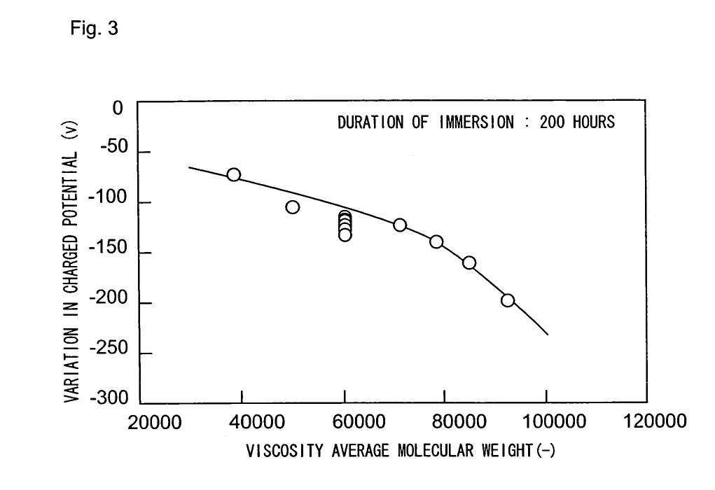

Here, referring now to FIGS. 2 and 3, the effect of a viscosity average molecular weight on the polycarbonate resin provided as a binder resin will be concretely described.

In FIG. 2, the viscosity average molecular weight is plotted along the abscissa and the amount of elution of a hole-transfer agent (g/cm²) after 200-hour-immersion of an electrophotographic photoconductor for wet developing in an isoparaffin solvent is plotted along the ordinate.

From FIG. 2, when the binder resin has a viscosity average molecular weight of 40,000 or more, the amount of elution of the hole-transfer agent reaches at 0.021 g/m² or less. On the other hand, when the binder resin has a viscosity average molecular weight of 60, 000 or more, the amount of the elution of the hole-transfer agent reaches at 0.013 g/m² or less. Thus, it is found that each of these cases represents comparatively good solvent resistance.

In addition, in FIG. 3, a relationship between the viscosity average molecular weight of the binder resin and the variations in charged potential is plotted along the abscissa. On the other hand, the variation of charged potential obtained by the evaluation on ozone resistance property described below is plotted along the ordinate.

The ozone resistance property becomes to be more preferable as the variation of charged potential is smaller. However, it is possible to provide a photoconductor which does not produce an image defect as far as the absolute value of the variation of charged potential is 145 volts or less. Therefore, from FIG. 3, it is found that the electrophotographic photoconductor for wet developing of the invention shows excellent ozone resistance property because the ozone resistance decreases as the viscosity average molecular weight increases and besides the variation of charged potential is 141 volts or less when the binder resin has a viscosity average molecular weight of 80,000 or less.

In other words, from FIGS. 2 and 3, it is recognized that an electrophotographic photoconductor for wet developing containing a binder resin having a viscosity average molecular weight of in the range of 40,000 to 80,000 is allowed to be imparted with excellent properties of solvent resistance and ozone resistance.

Furthermore, the term “evaluation on ozone resistance property” represents variations in charged potential obtained by making a comparison between an initial charged potential and the measured surface potential of an electrophotographic photoconductor for wet developing after the exposure thereof to ozone.

That is, mounting the electrophotographic photoconductor for wet developing on a digital copier, Creage 7340 (manufactured by Kyocera Mita Corp.), then charging at 800 volts to thereby determine an initial charged potential (V₀). Subsequently, dismounting the electrophotographic photoconductor for wet developing from the digital copier and placing in a dark place adjusted to an ozone concentration of 10 ppm and remaining untouched for 8 hours at room temperature. Next, after completing the step of leaving the photoconductor untouched in an exposure state and then leaving it untouched for 1 hour, remounting the electrophotographic photoconductor for wet developing on the digital copier, determining the surface potential of the photoconductor at 60 seconds after the initiation of charging and providing a post-exposure surface potential (V_{E}) . Variation in charged potential (V_{E}−V_{O}) for the evaluation on ozone resistance property is defined by subtracting the initial charge potential (V_{O}) from the post-exposure surface potential (V_{E}).

(3) Charge-Generating Agent

The charge-generating agent of the invention includes, for example, the charge-generating agents of well-known prior arts; organic photoconductor materials such as phthalocyanine pigments such as metal-free phthalocyanine and oxo-titanyl phthalocyanine, perylene pigments, bisazo pigments, dioctopyrroropyrrole pigments, metal-free naphthalocyanine pigments, metal naphthalocyanine pigments, squaline pigments, trisazo pigments, indigopigments, azuleniumpigments, cyanine pigments, pyrylium pigments, anthanthrone pigments, triphenyl methane pigments, threne pigments, toluidine pigments, pyrazoline pigments and quinacridone pigments; and inorganic photoconductor materials such as selenium, selenium-tellurium, selenium-arsenic, cadmium sulfide and amorphous silicon.

Concretely, phthalocyanine pigments (CGM-1 to CGM-49) represented by the following formulas (3) are preferably used among these charge-generating agents:

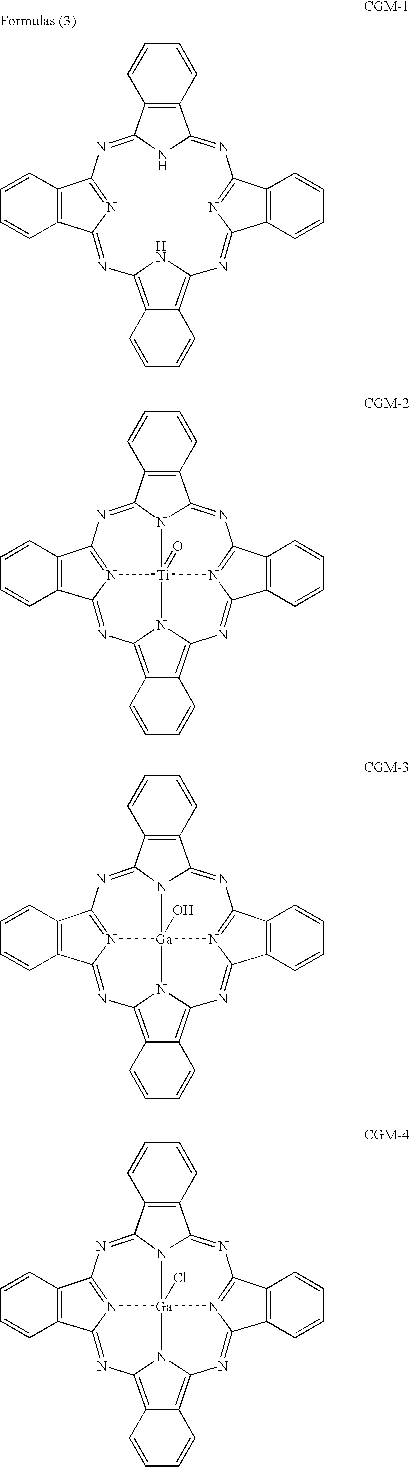

In addition, among the charge-generating agents described above, a photoconductor having sensitivity at wavelengths of not less than 700 nm is required particularly when it is used in a digital optical image-forming apparatus such as a laser beam printer or a facsimile machine equipped with an optical source such as a semiconductor laser. Therefore, it is preferable that the photoconductor may contain at least one of metal-free phthalocyanine, titanyl phthalocyanine, hydroxygallium phthalocyanine and chlorogallium phthalocyanine.

On the other hand, when it is used for an analog optical image-forming apparatus such as an electrostatic copier equipped with a white optical source such as a halogen lamp, a photoconductor having sensitivity at wavelengths in the visible area is required. Therefore, for example, perylene pigments or bisazo pigments may be preferably used.

Furthermore, in the case of a monolayer photoconductor, the amount of addition of a charge-generating agent is preferably in the range of 0.1 to 50% by weight, more preferably in the range of 0.5 to 30% by weight with respect to the total amount of the whole binder resin.

(4) Electron-Transfer Agent

(4)-1 Variety

Electron-transfer agents include various kinds of compounds having electron-accepting properties such as diphenoquinone derivatives, benzoquinone derivatives, anthraquinone derivatives, malononitrile derivatives, thyopyrane derivatives, trinitrothioxanthone derivatives, 3,4,5,7-tetranitro-9-fluolenone derivatives, dinitroanthraquinone derivatives, dinitroacridine derivatives, nitroanthraquinone derivatives, dinitroanthraquinone derivatives, tetracyanoethylene, 2,4,8-trinitrothioxanthone, dinitrobenzene, dinitroanthracene, dinitroacrydine, nitroanthraquinone, dinitroanthraquinone, succinic anhydride, maleic anhydride and dibromo maleic anhydride, which may be used independently or used as a combination of two or more thereof.

Among these compounds, furthermore, a more preferable compound is one having an electron mobility of 1.0×10⁻⁸ cm²/V. sec or more at an electric field strength of 5×10⁵ V/cm.

Preferably, furthermore, the electron-transfer agents may include naphthoquinone derivatives or azoquinone derivatives because of the following reasons: Such compounds exert excellent electron-accepting properties and excellent compatibility with electron-transfer agents when they are used as electron-transfer agents, resulting in an electrophotographic photoconductor for wet developing having excellent characteristics of sensitivity and solvent resistance.

Furthermore, regarding the varieties of the electron-transfer agent, it is preferable to have at least one of a nitro group (—NO₂), substituted carboxyl group (—COOR (R is a substituted or unsubstituted alkyl group having 1 to 20 carbon atoms or a substituted or unsubstituted aryl group having 6 to 30 carbon atoms)) and a substituted carbonyl group (—COR (R is a substituted or unsubstituted alkyl group having 1 to 20 carbon atoms, and a substituted or unsubstituted aryl group having 6 to 30 carbon atoms).

This is because, by having such specific substitute, an electrophotographic photoconductor for wet developing having solvent resistance may be obtained.

Furthermore, with respect to the varieties of the electron-transfer agents, concretely, the compounds represented by the following formulas (4), (5), (6), and (7) are preferable. 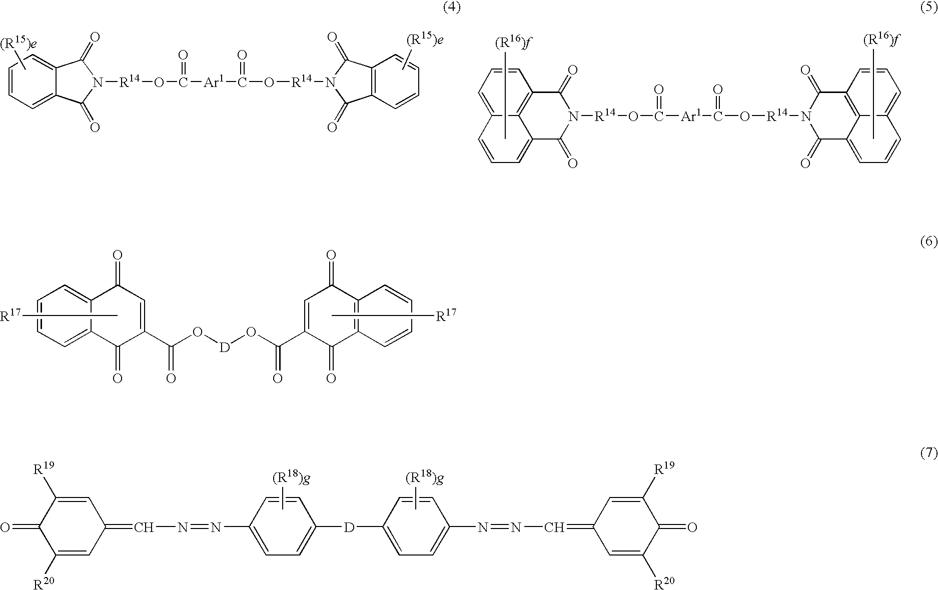
(In the general formulas (4) to (7), R¹⁴ represents an alkylene group having 1 to 8 carbon atoms, an alkylidene group having 2 to 8 carbon atoms, or a divalent organic group represented by the general formula: —R²¹—Ar¹—R²²— (wherein R²¹ and R²² are alkylene group having carbon atoms 1 to 18 or alkylidene group having 2 to 8 carbon atoms, and Ar¹ is an allylene group having 6 to 8 carbon atoms); each of R⁵ to R^{2 0}independently represents a halogen atom, a nitro group, an alkyl group having 1 to 8 carbon atoms, an alkenyl group having 2 to 8 carbon atoms, or an aryl group having 6 to 18 carbon atoms; e, f, and g represent integers of 0 to 4; D represents a single bond, an alkylene group having 1 to 8 carbon atoms, or an alkylidene group having 2 to 8 carbon atoms or a divalent organic group represented by the general formula: —R²³—Ar¹—R²⁴— (R²³ and R²⁴ represents an alkylene group having carbon atoms 1 to 8 or an alkylidene group having 2 to carbons, and Ar¹ represents an arylene group having 6 to 18 carbon atoms).
(4)-2 Concrete Examples

Furthermore, for further improvements in solvent resistance (anti-developer property) and charging characteristics, an electron-transfer agent itself may have small solubility characteristics against paraffin solvent as well as high electron transfer property even in small quantity. Examples of such an electron-transfer agent include compounds (ETM-1 to 9) represented by the following formula (8), which are suitably used. 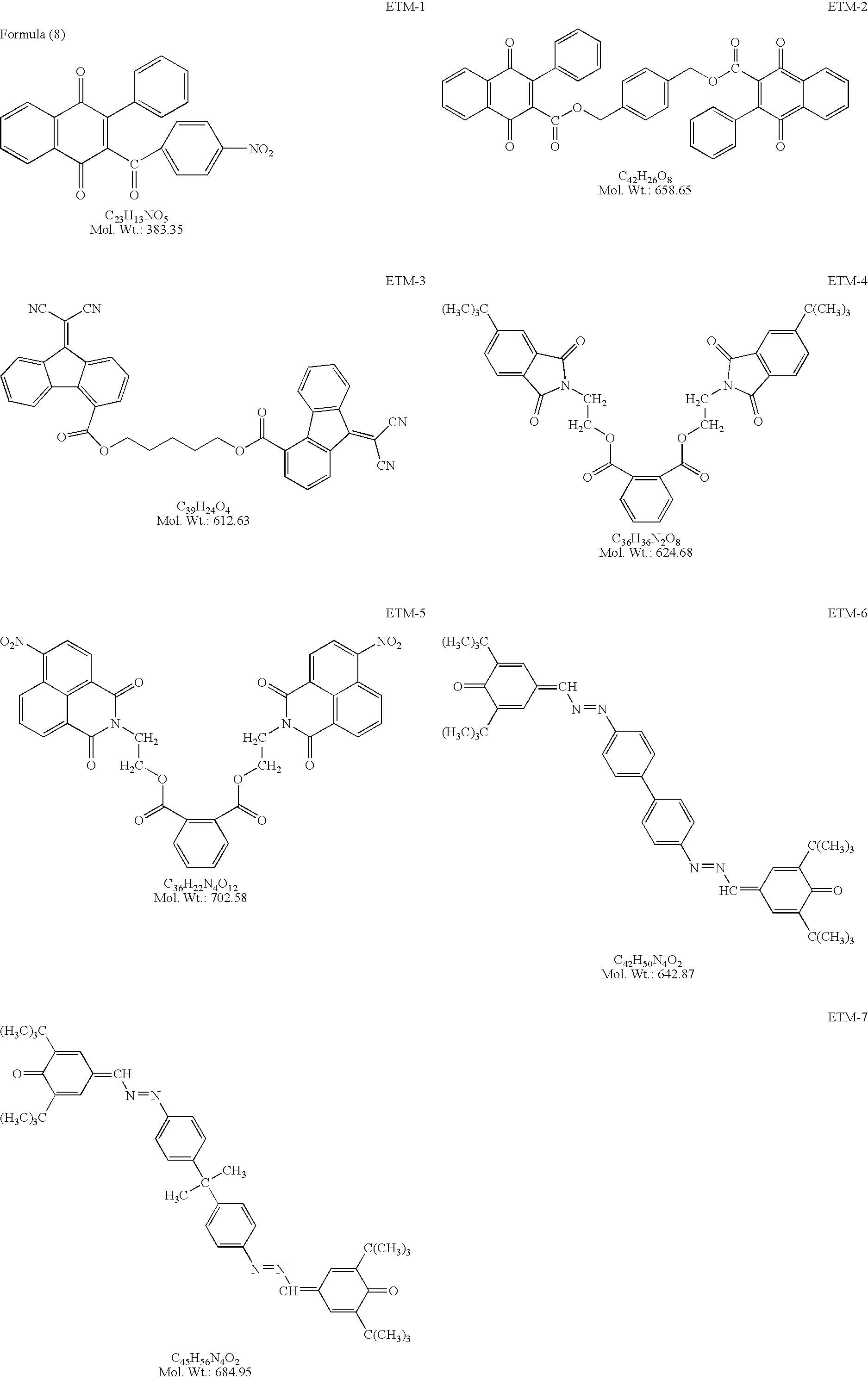 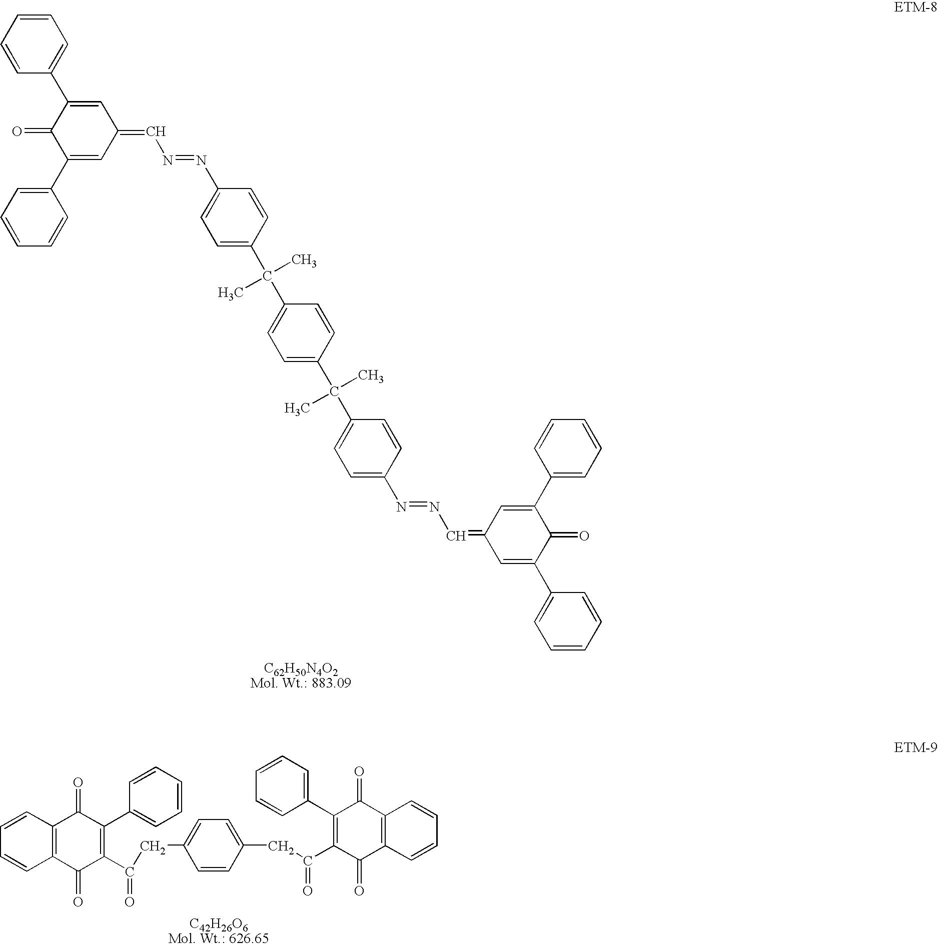
(4)-3 Amount of Addition

For constructing an electrophotographic photoconductor for wet developing, the amount of addition of the electron-transfer agent is preferably in the range of 10 to 100 parts by weight with respect to 100 parts by weight of a binder resin.

This is because, when the amount of the addition of each of the electron-transfer agents listed above becomes less than 10 parts by weight, the sensitivity of the photoconductor decreases and thus any trouble may cause in practical use. On the other hand, when the amount of addition of the electron-transfer agent exceeds 100 parts by weight, the electron-transfer agent tends to be crystallized and thus a proper film may be not formed as a photoconductor.

Therefore, it is more preferable that the amount of the addition of the electron-transfer agent is in the range of 10 to 80 parts by weight with respect to 100 parts by weight of the binder resin.

For determining the amount of the addition of the electron-transfer agent, it is preferable to consider the amount of the addition of the hole-transfer agent, which will be described later. More concretely, the ratio (ETM/HTM) of the amount of the addition of the electron-transfer agent (ETM) is preferably in the range of 0.25 to 1.3 with respect to the amount of the addition of the hole-transfer agent (HTM).

This is because, when the ratio of ETM/HTM is out of the range, the sensitivity of the photoconductor decreases and thus any trouble may cause in practical use. Therefore, it is preferable that the ratio of the total ETM/the total HTM is in the range of 0.5 to 1.25.

(4)-4 Elution Amount

For the amount of elution of the hole-transfer agent, furthermore, it is characterized that the amount of the elution of the hole-transfer agent after 2,000-hour-immersion in paraffin solvent having a kinematic viscosity (25° C., in accordance with ASTM D445) of 1.4 to 1.8 mm²/s is 0.12 g/m² or less.

This is because the repeat characteristics of an electrophotographic photoconductor for wet developing after long-term usage may be precisely estimated by the use of a specific paraffin solvent to restrict the amount of the elution of the electron-transfer agent eluted at 2,000 hours. Therefore, the repeat characteristics of the photoconductor, for example after carrying out image formation on 100,000 sheets of paper, may be also estimated by carrying out a 2,000-hour-immersion experiment under predetermined conditions.

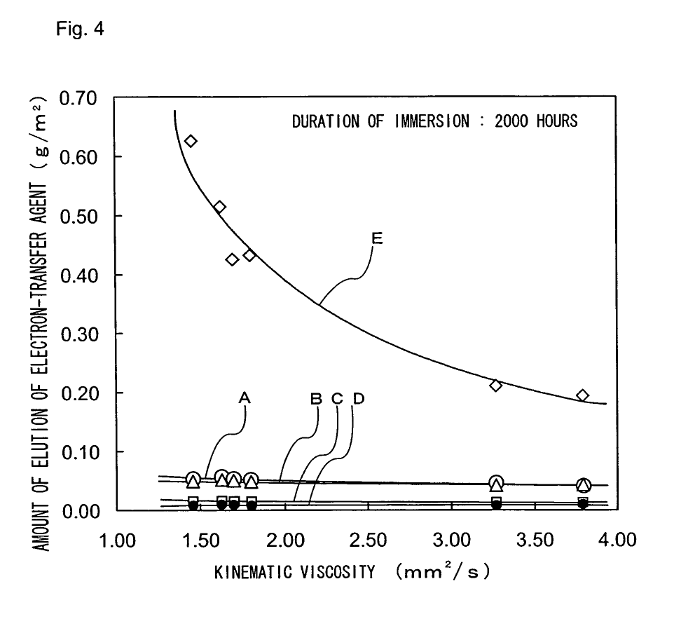

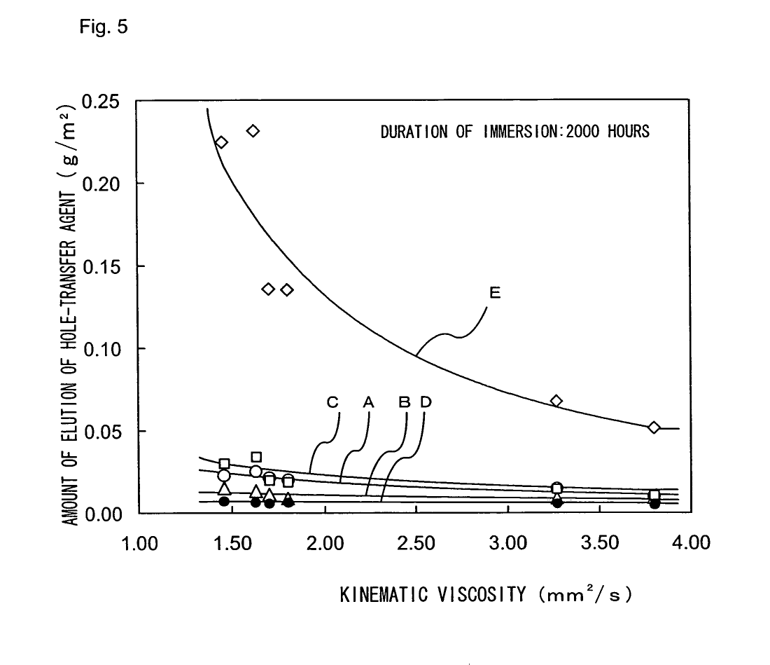

Furthermore, the paraffin solvent is characterized by having predetermined kinematic viscosity. This is due to a cross relationship between the kinematic viscosity and the amount of the electron- or hole-transfer agent as shown later in FIG. 4 or FIG. 5.

Furthermore, examples of the paraffin solvent having a predetermined kinematic viscosity, which may be suitably used, include those commercially available from Exxon Chemicals in the name of Isopar G, Isopar L, Isopar H, Isopar N, and Norpar 12. It is also preferable to elevate the ambient temperature to 50 to 80° C. or add a diluent or the like when the kinematic viscosity of the paraffin solvent is out of the predetermined range at room temperature.

Furthermore, the content of an aromatic component in the paraffin solvent is preferably in the range of 0.05% by weight or less, more preferably in the range of 0.001 to 0.03% by weight with respect to the total amount thereof because of the following reasons: The kinematic viscosity of the paraffin solvent or an immersion state thereof may be varied depending on the content of the aromatic component in the paraffin solvent. In other words, by lowering the content of the aromatic component, a change in solvent resistance, charging characteristics, or repeat characteristics may be precisely estimated.

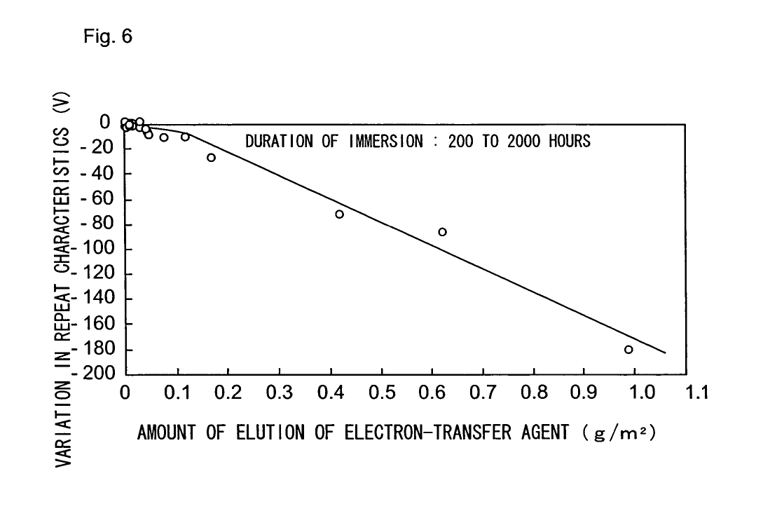

Here, referring to FIG. 6, we will describe the relationship between the amount of elution of an electron-transfer agent and the repeat characteristics of an electrophotographic photoconductor for wet developing. In FIG. 6, variations in the amount of elution of the electron-transfer agent (g/m²) when the electrophotographic photoconductor for wet developing is immersed in solvent after 200 to 2,000-hour-immersion in the solvent characteristics of an electron-transfer material are plotted along the abscissa, while variations in repeat characteristics (V) of the electrophotographic photoconductor for wet developing are plotted along the ordinate.

Then, from the characteristic diagram shown in FIG. 6, it may be easily recognized that, when the amount of elution of an electron-transfer agent to the predetermined paraffin solvent is 0.12 g/m² or less, variations in repeat characteristics (V) of the electrophotographic photoconductor for wet developing becomes substantially small. And it may be easily recognized that a difference between the initial charged potential and the post-running charged potential becomes excessively small.

However, when the amount of the elution of the electron-transfer agent is extensively small in the paraffin solvent, the range of choice for variety of usable electron-transfer agents may be extensively small.

Therefore, for example, the amount of the elution of the electron-transfer agent after 2,000-hour-immersion in paraffin solvent is adjusted within the range of 0.0001 to 0.1 g/m² so that variations (V) in repeat characteristics of the electrophotographic photoconductor for wet developing may be decreased more stably, while allowing the range of choice for the variety of the usable electron-transfer agent to be comparatively extended.

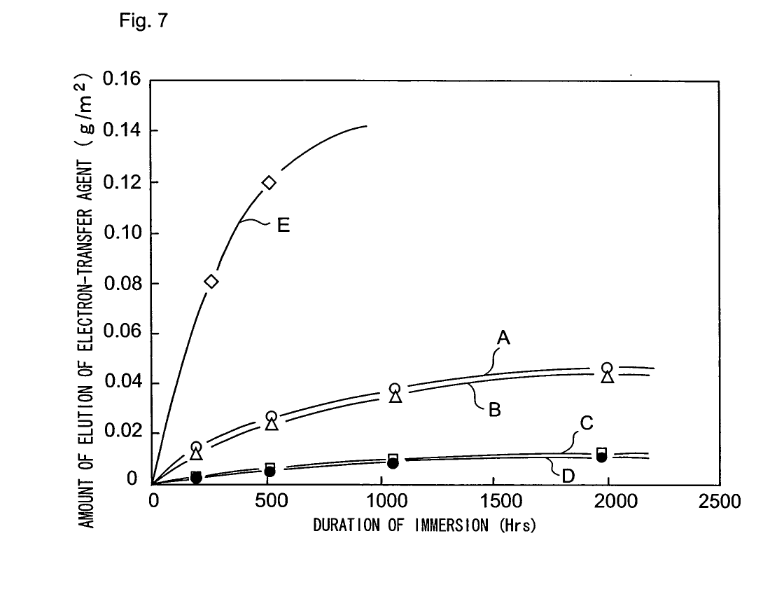

Referring now to FIG. 7, the relationship between the duration of immersion of an electrophotographic photoconductor for wet developing and the amount of elution of the electron-transfer agent will be described. In FIG. 7, variations in immersion time (Hrs) of the electrophotographic photoconductor for wet developing are plotted along the abscissa, while variations in amount of the elution of the electron-transfer agent per unit area of electrophotographic photoconductor for wet developing (g/m²) are plotted along the ordinate.

Furthermore, from several characteristic lines A to E (corresponding to Examples 1 to 4 and the Comparative Example 1) shown in FIG. 7, it is found that the amount of the elution of the electron-transfer agent tends to be increased as far as the duration of immersion of the electrophotographic photoconductor for wet developing is extended. Concretely, there is an electrophotographic photoconductor for wet developing having a comparatively low amount of elution of an electron-transfer agent and duration of immersion of about 200 hours. For instance, in the case of the characteristic line A, it is easily recognized that the amount of the elution of the electron-transfer agent is comparatively small even after extending the immersion time to about 2,000 hours.

That is, it may be estimated that good variations (V) in repeat characteristics of an electrophotographic photoconductor for wet developing when the amount of elution of an electron-transfer agent after 200-hour-immersion in paraffin solvent is set to 0.03 g/m² or less.

However, when the amount of the elution of the electron-transfer agent is extensively small after 200-hour-immersion in the paraffin solvent, the range of choice for variety of usable electron-transfer agents may be extensively small.

Therefore, by limiting the amount of the elution of the electron-transfer agent after 200-hour-immersion in the paraffin solvent within the range of 0.0001 to 0.025 g/m², we may estimate variations in repeat characteristics of the electrophotographic photoconductor for wet developing after long-term usage and also the range of choice for variety of the useable electron-transfer agents may be comparatively extended.

Referring now to FIG. 4, furthermore, the relationship between the kinematic viscosity of paraffin solvent in which an electrophotographic photoconductor for wet developing is immersed and the amount of elution of an electron-transfer agent after the duration of 2,000-hour-immersion will be described. That is, in FIG. 4, variations in kinematic viscosity (mm²/s) of the paraffin solvent in which the electrophotographic photoconductor for wet developing is immersed are plotted along the abscissa, while variations in the amount of the elution of the electron-transfer agent per unit area (g/m²) of the electrophotographic photoconductor for wet developing are plotted along the ordinate.

Furthermore, although it is variable depending on the kinds of the electrophotographic photoconductor for wet developing (A to E), it is favorable that lower kinematic viscosity of the paraffin solvent provides more amount of the elution of the electron-transfer agent eluted.

In other words, using a paraffin solvent having a kinematic viscosity (25° C., in accordance with ASTM D445) of 1.4 to 1.8 mm²/s permits the elution phenomenon of an electron-transfer agent to be tenderly reproduced. Therefore, variations in repeat characteristics of the electrophotographic photoconductor for wet developing may be precisely estimated after long-term usage thereof.

(4)-5 Molecular Weight

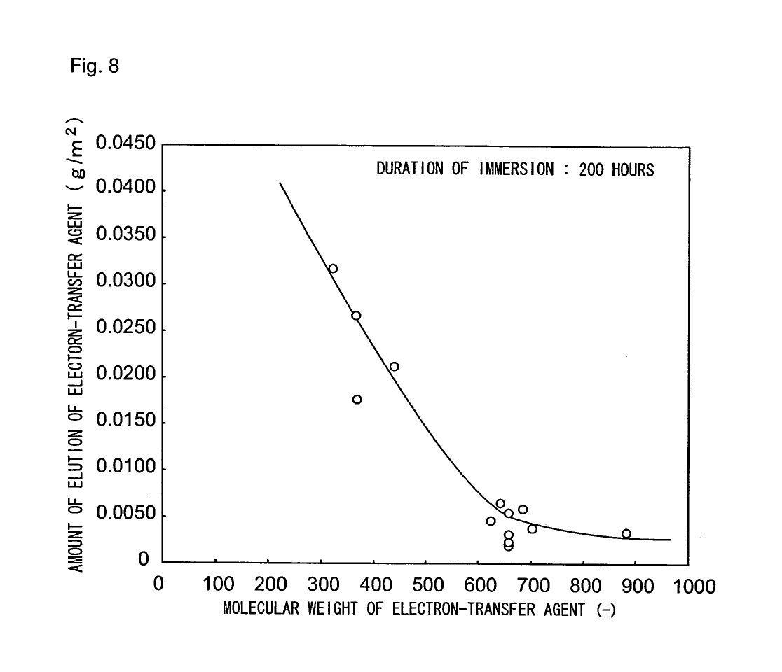

Furthermore, it is preferable that the molecular weight of the electron-transfer agent is 600 or more because of the following reasons: As shown in FIG. 6 and FIG. 8, by designing the electron-transfer agent to have a molecular weight of 600 or more, the solvent resistance thereof to a hydrocarbon solvent may be improved to extensively diminish variations in repeat characteristics of a photoconductive layer as well as effectively inhibit elution therefrom.

However, when the electron-transfer agent has an extensively large molecular weight, a decrease in dispersibility thereof in the photoconductive layer or a decrease in hole-transfer ability may occur. Therefore, the electron-transfer agent has a molecular weight of preferably in the range of 600 to 2,000, more preferably in the range of 600 to 1,000.

Furthermore, the molecular weight of the electron-transfer agent may be calculated on the basis of its chemical formula using ChemDraw Standard Version 8 (Software, manufactured by Cambridge Soft, Co., Ltd.) or may be calculated using a mass spectrum.

(5) Hole-Transfer Agent

(5)-1 Variety

Furthermore, regarding to the variety of a hole-transfer agent, examples thereof include N,N,N′,N′-tetraphenyl benzidine derivatives, N, N, N′,N′-tetraphenyl penylene diamine derivatives, N,N,N′,N′-tetraphenyl naphtylene diamine derivatives, N,N,N′,N′-tetraphenyl phenanthlene diamine derivatives, oxadiazole compounds, stilbene compounds, styryl compounds, carbazole compounds, organic polysilane compounds, pyrazoline compounds, hydrazone compounds, indole compounds, oxazole compounds, isoxazole compounds, thiazole compounds, thiadiazole compounds, imidazole compounds, pyrazole compounds and triazole compounds, which may be used alone or in combination of two or more thereof. Among these hole-transfer agents mentioned above, the stilbene compounds having their respective portions represented by the general formula (1) are preferable.

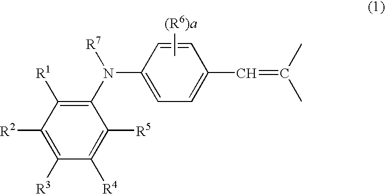

In the general formula (1), each of R¹ to R⁷ independently represents a hydrogen atom, a halogen atom, a substituted or unsubstituted alkyl group having 1 to 20 carbon atoms, a substituted or unsubstituted aryl group having 2 to 20 carbon atoms, a substituted or unsubstituted aryl group, a substituted or unsubstituted aralkyl group having 6 to 30 carbon atoms, a substituted or unsubstituted azo group or a substituted or unsubstituted diazo group having 6 to 30 carbon atoms, and the number of repetitions “a” is an integer of 1 to 4.

Concrete examples of such hole-transfer agents are stilbene derivatives represented by the general formulas (9) to (18).

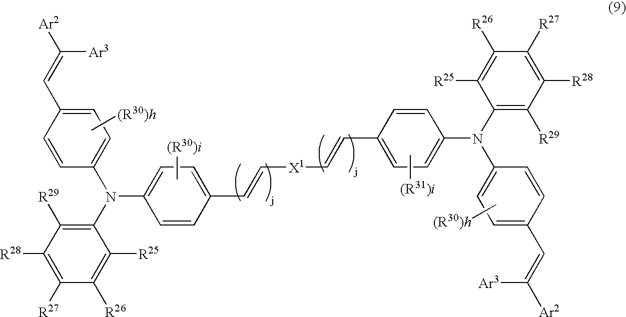

In the general formula (9), X1 represents a divalent organic group having an aromatic hydrocarbon as a main skeleton. Each of plural R⁵ to R³¹ is an independent substituent which may be a hydrogen atom, a halogen atom, a substituted or unsubstituted alkyl group having 1 to 20 carbon atoms, a substituted or unsubstituted halogenated alkyl group having 1 to 20 carbon atoms, a substituted or unsubstituted carbon alkyl having 1 to 20 carbon atoms, a substituted or unsubstituted aryl group having 6 to 30 carbon atoms and a substituted or unsubstituted amino group. Any two of plural R²⁵ to R³¹ may be bound or condensed together to form a carbon ring structure. Plural Ar² and Ar³ are independent from each other and each of them is a substituted or unsubstituted aryl group having 6 to 30 carbon atoms. The numbers of repetitions “h” and “i” each represents an integer of 0 to 4, and “j” represents an integer of 1 to 3. However, when X¹ is a divalent organic group represented by the formula (10) below, at least one of plural R⁵ and P²⁹ is a substituent except of a hydrogen atom, and when X¹ is a divalent organic group having an aromatic hydrocarbon except of one represented by the formula (10) below as a main skeleton, at least one of R²⁵ and P³¹ is a substituent except of a hydrogen atom.

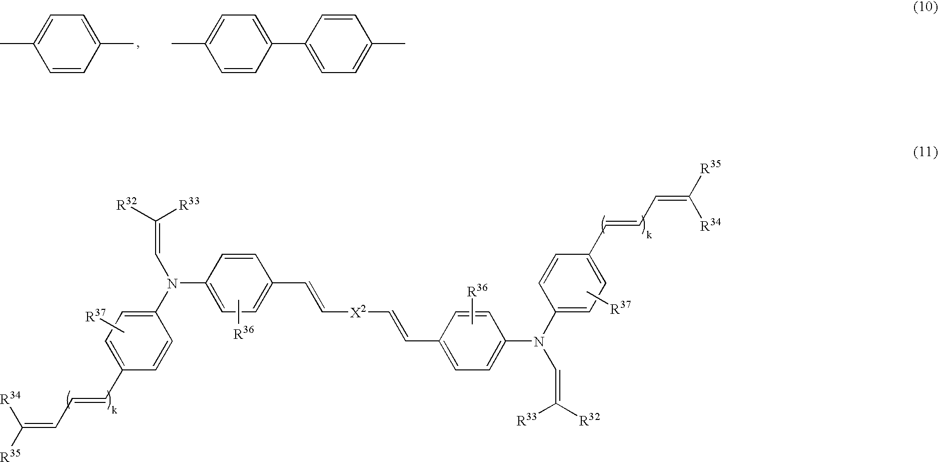

In the general formula (11), plural R³² to R³⁷ are independent from each other and each represents a hydrogen atom, a halogen atom, a substituted or unsubstituted alkyl group having 1 to 20 carbon atoms, a substituted or unsubstituted fluoroalkyl group having 1 to 20 carbon atoms, a substituted or unsubstituted alkoxy group having 1 to 20 carbon atoms or a substituted or unsubstituted aryl group having 6 to 30 carbon atoms. R³⁶ and R³⁷ maybe bound to form a single bond or a vinylene group. X² is a divalent organic group having an aromatic ring. k is an integer of 0 or 1.

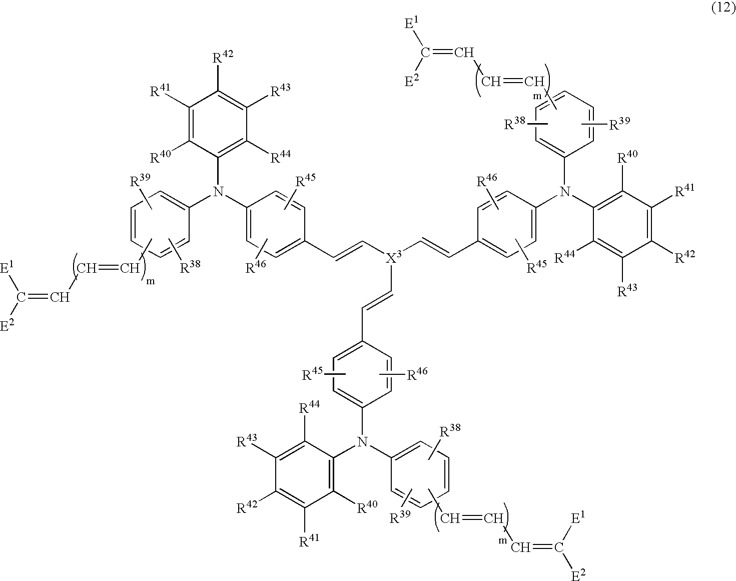

In the general formula (12), X³ is a trivalent organic group having a substituted or unsubstituted aromatic group. Plural R³⁸ to R⁴⁶, E¹ and E² each independently represents a hydrogen atom, a halogen atom, a substituted or unsubstituted alkyl group having 1 to 20 carbon atoms, a substituted or unsubstituted halogenated alkyl group having 1 to 20 carbon atoms, a substituted or unsubstituted alkoxyl group having 1 to 20 carbon atoms, a substituted or unsubstituted aryl group having 6 to 30 carbon atoms, a substituted or unsubstituted ethenyl group having 2 to 30 carbon atoms and a substituted or unsubstituted aralkyl group having 7 to 31 carbon atom. Two of R³⁸ to R⁴⁶, E¹ and E² may be bound or condensed together to form a carbon ring structure, and the number of repetitions “m” is an integer of 0 to 2.

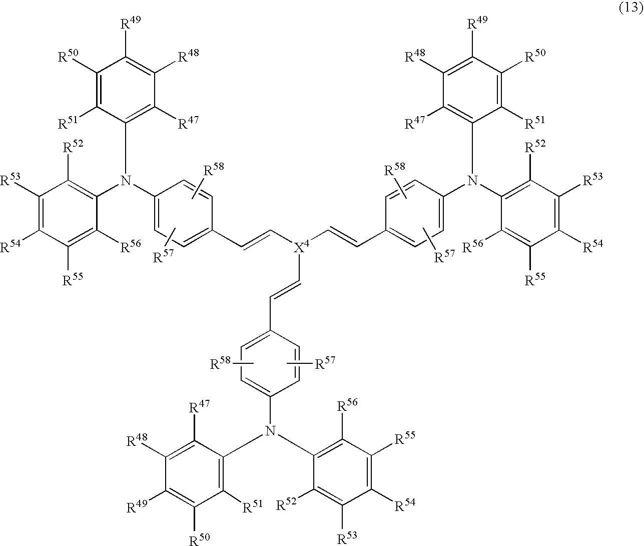

In the general formula (13), X⁴ represents a trivalent organic group having a substituted or unsubstituted aromatic group. Plural R⁴⁷ to R⁵⁸ each independently represents a hydrogen atom, a halogen atom, a substituted or unsubstituted alkyl group having 1 to 20 carbon atoms, a substituted or unsubstituted halogenated alkyl group having 1 to 20 carbon atoms, a substituted or unsubstituted alkoxyl group having 1 to 20 carbon atoms, a substituted or unsubstituted aryl group having 6 to 30 carbon atoms and a substituted or unsubstituted aralkyl group having 7 to 31 carbon atoms. Two of R⁴⁷ to R⁵⁸ may be bound or condensed together to form a carbon ring structure.

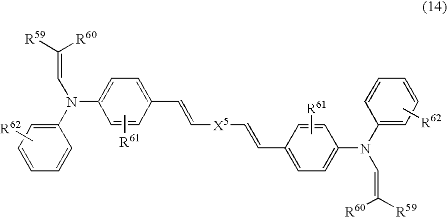

In the general formula (14), X⁵ represents a divalent organic group having a substituted or unsubstituted aromatic ring. Plural R⁵⁹ and R⁶⁰ each independently represents a substituted or unsubstituted alkyl group having 1 to 10 carbon atoms, a substituted or unsubstituted halogenated alkyl group having 1 to 10 carbon atoms and a substituted or unsubstituted aryl group having 6 to 20 carbon atoms. Plural R⁶¹ represents a hydrogen atom, a halogen atom, a substituted or unsubstituted alkyl group having 1 to 10 carbon atoms, a halogenated alkyl group having 1 to 10 carbon atoms and a substituted or unsubstituted aryl group having 6 to 20 carbon atoms. Plural R⁶² represents a hydrogen atom, a halogen atom, a substituted or unsubstituted alkyl group having 1 to 10 carbon atoms, a substituted or unsubstituted halogenated alkyl group having 1 to 10 carbon atoms, a substituted or unsubstituted aryl group having 6 to 20 carbon atoms, a substituted or unsubstituted aralkyl group having 7 to 30 carbon atoms, a aryl-substituted alkenyl group having 8 to 30 carbon atoms or —OR⁶³ (where R⁶³ is a substituted or unsubstituted alkyl group having 1 to 12 carbon atoms, and a substituted or unsubstituted aryl group having 6 to 20 carbon atoms).

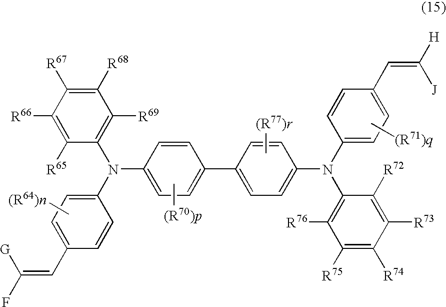

In the general formula (15), F, G, H, J, and R⁶⁴ to R⁷⁷ each independently represents a hydrogen atom, a halogen atom, a substituted or unsubstituted alkyl group having 1 to 20 carbon atoms, a substituted or unsubstituted halogenated alkyl group having 1 to 20 carbon atoms, a substituted or unsubstituted alkoxy group having 1 to 20 carbon atoms, a substituted or unsubstituted aryl group having 6 to 20 carbon atoms or a substituted or unsubstituted amino group. Two of R⁶⁵ to R⁶⁹ and two of R⁷²to R⁷⁶ may be bound or condensed together to form a carbon ring structure. Each of the numbers of repetitions n, p, q and r is independently an integer of 0 to 4.

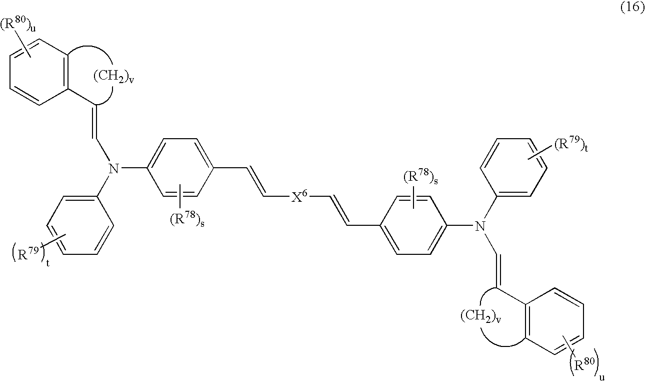

In the general formula (16), X⁶ represents a divalent organic group having a substituted or unsubstituted aromatic ring. Plural R⁷⁸ to R⁸⁰ each independently represents a hydrogen atom, a halogen atom, a substituted or unsubstituted alkyl group having 1 to 20 carbon atoms, a substituted or unsubstituted aryl group having 6 to 30 carbon atoms, a halogenated alkyl group having 1 to 20 carbon atoms, a substituted or unsubstituted alkenyl group having 2 to 30 carbon atoms, an alkoxy group having 1 to 25 carbon atoms or an aralkyl group having 7 to 30 carbon atoms. Each of the numbers of repetitions s and u is an integer of 0 to 4, t is an integer of 0 to 5, and v is an integer of 2 or 3.

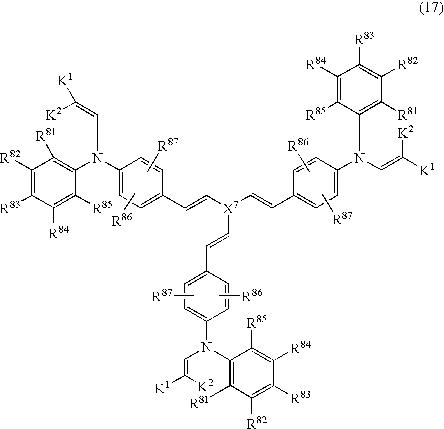

In the general formula (17), X⁷ is a trivalent organic group having a substituted or unsubstituted aromatic group. Plural R⁸¹ to R⁸⁷, K¹ and K² each independently represents a hydrogen atom, a halogen atom, a substituted or unsubstituted alkyl group having 1 to 20 carbon atoms, a substituted or unsubstituted halogenated alkyl group having 1 to 20 carbon atoms, a substituted or unsubstituted alkoxyl group having 1 to 20 carbon atoms, a substituted or unsubstituted aryl group having 6 to 20 carbon atoms, a substituted or unsubstituted amino group, a substituted or unsubstituted ethenyl group having 2 to 30 carbon atoms or a substituted or unsubstituted styryl group having 8 to 20 carbon atoms. Plural K¹ and K² may be bound or condensed together to form a substituted or unsubstituted carbon ring structure.

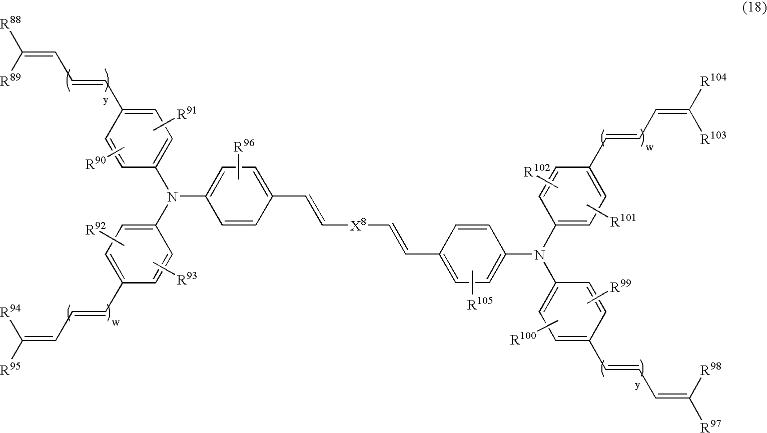

In the general formula (18), X⁸ represents a divalent organic group having a substituted or unsubstituted aromatic ring. Plural R⁸⁸ to R¹⁰⁵ each independently represents a hydrogen atom, a halogen atom, an alkyl group having a substituted or unsubstituted alkyl group having 1 to 8 carbon atoms, a substituted or unsubstituted aryl group having 6 to 24 carbon atoms, a substituted or unsubstituted aralkyl group having 7 to 12 carbon atoms, a substituted or unsubstituted cycloalkyl group having 3 to 10 carbon atoms, or a substituted or unsubstituted alkoxy group having 1 to 8 carbon atoms and a substituted or unsubstituted halogenated alkyl group having 1 to 8 carbon atoms. The numbers of repetitions w and y each independently represents an integer of 0 to 2. However, at least two of R⁸³ to R¹⁰⁵ may be bound or condensed to form a carbocyclic group or heterocyclic group.

(5)-2 Concrete Examples

Preferably, furthermore, more concrete examples of such hole-transfer agents are compounds (HTM-1 to 35) represented by the formula (19). 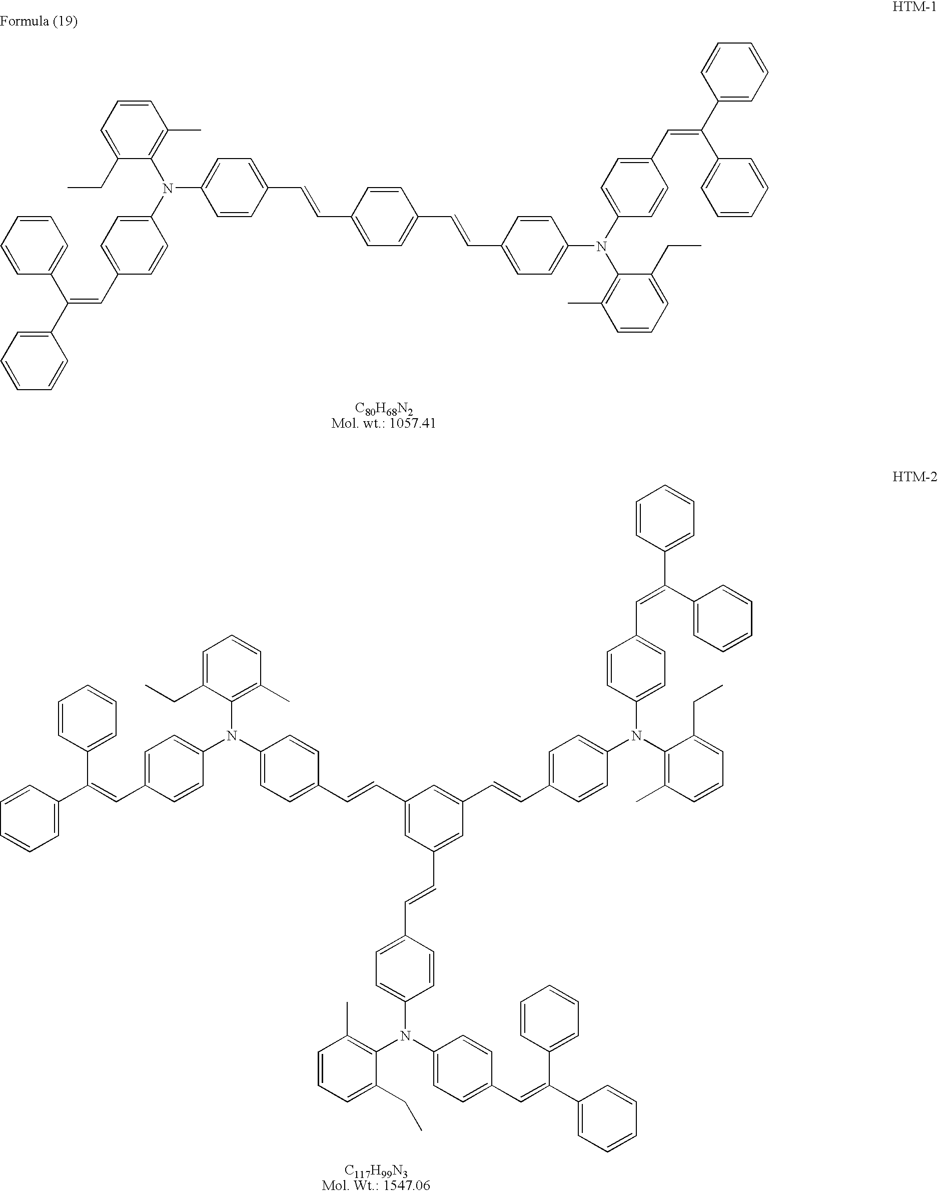 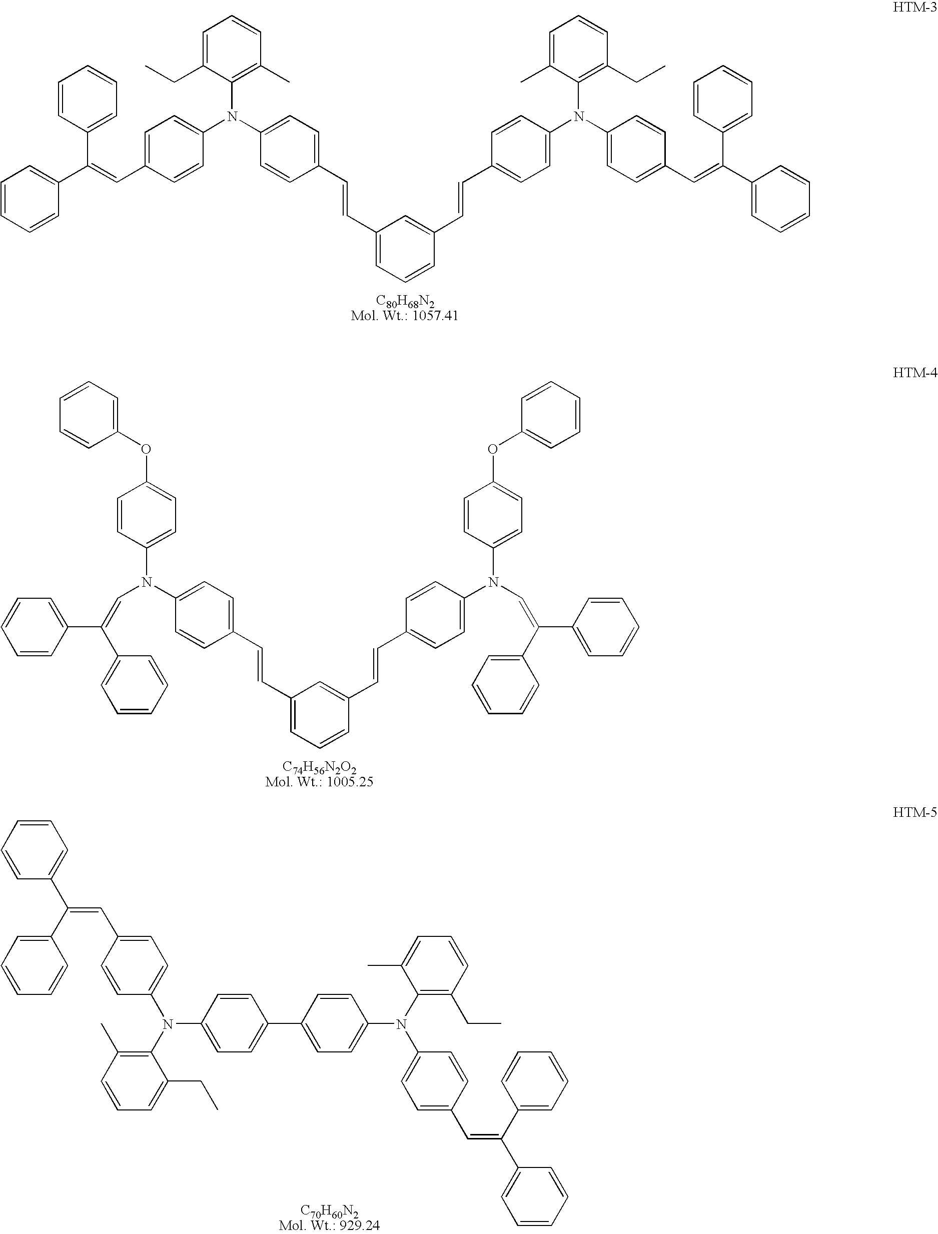 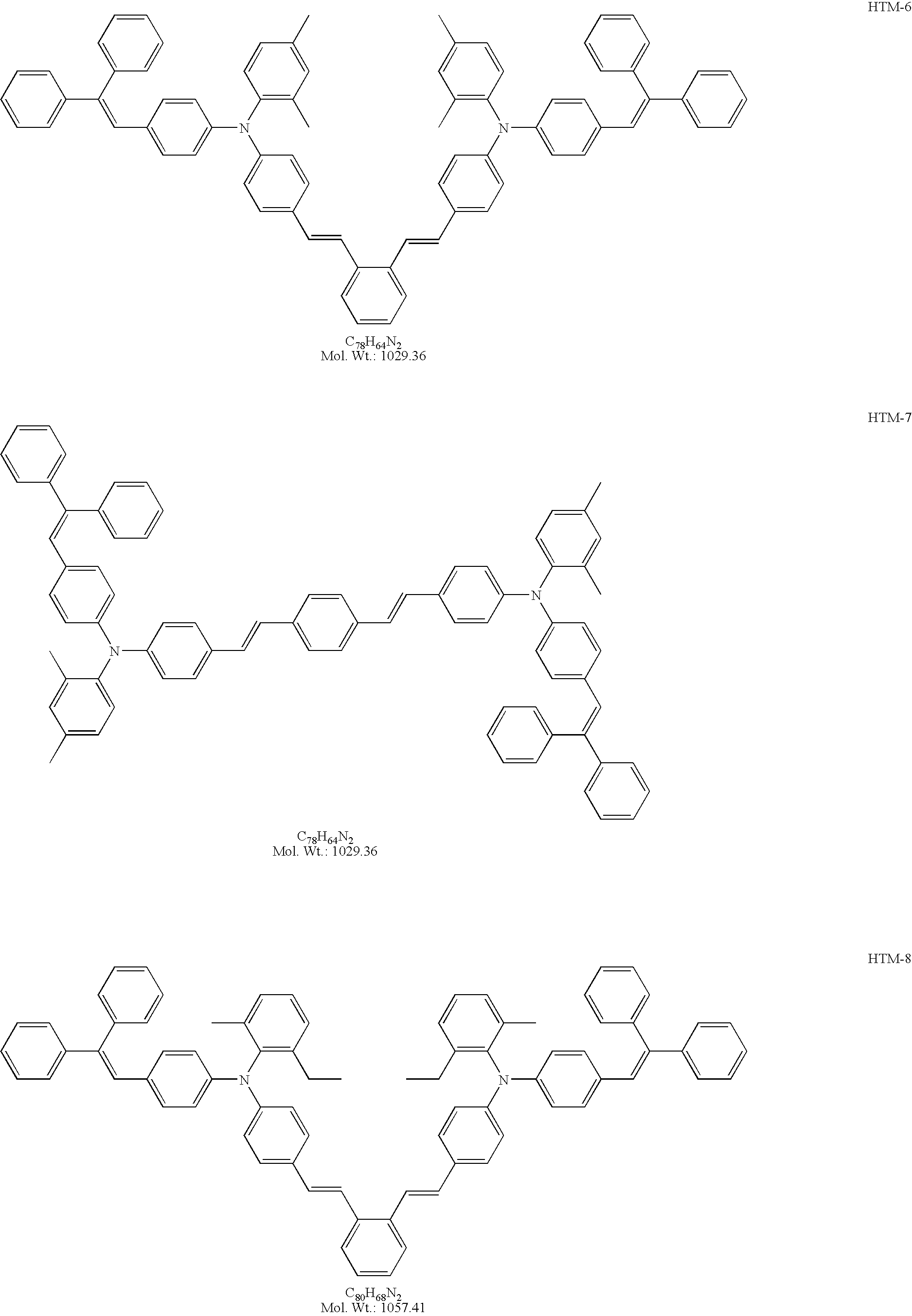 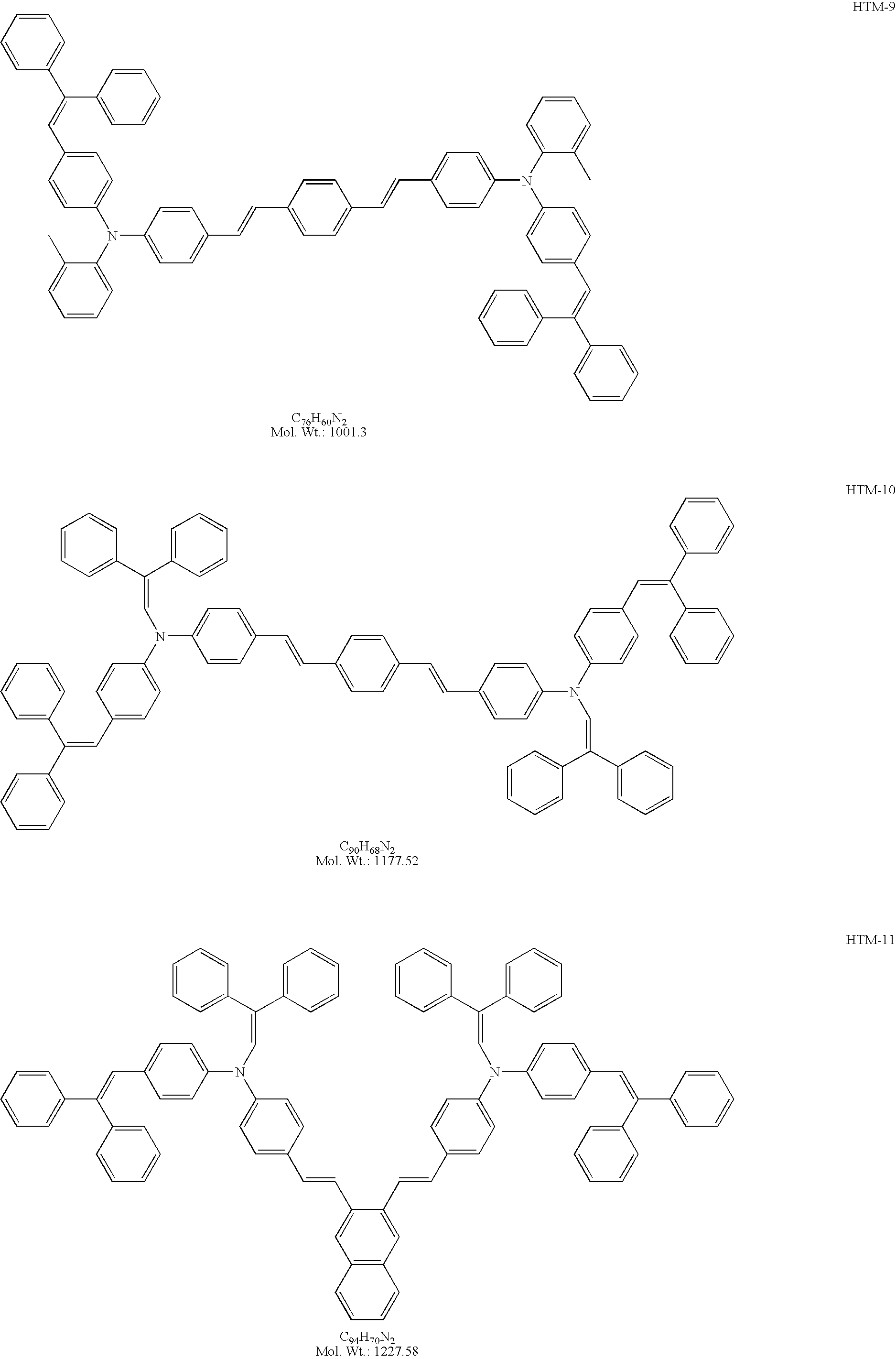 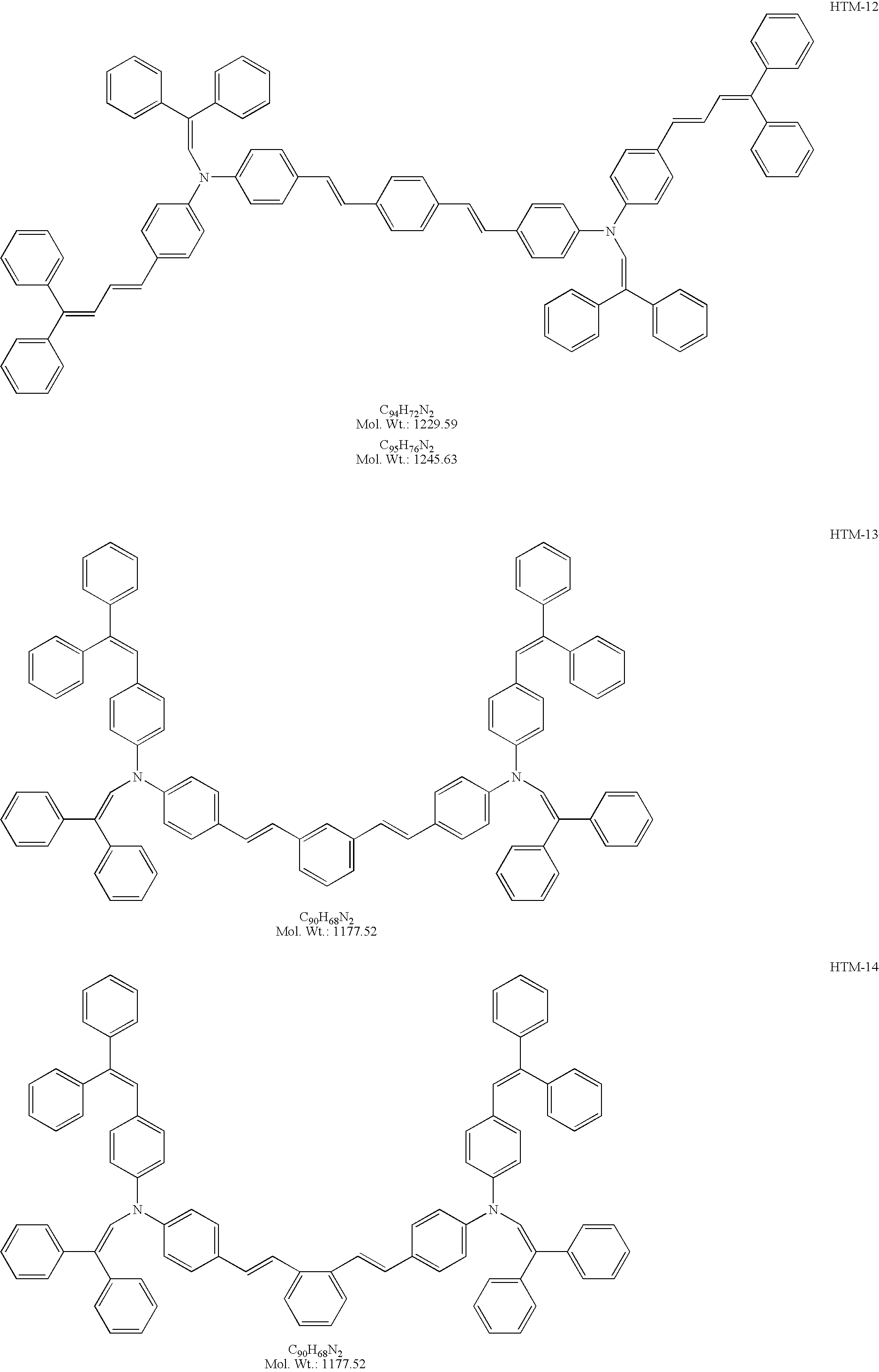 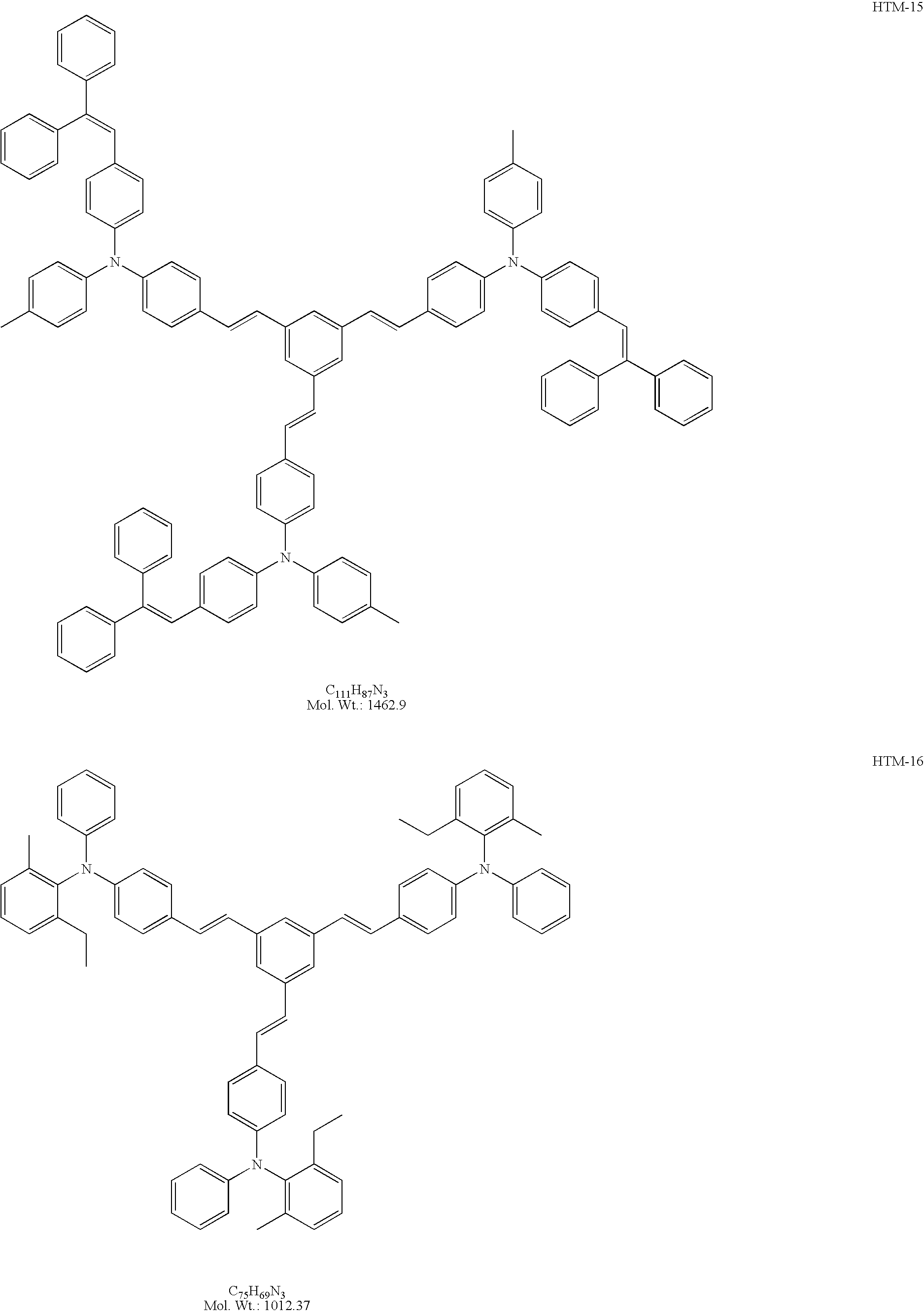 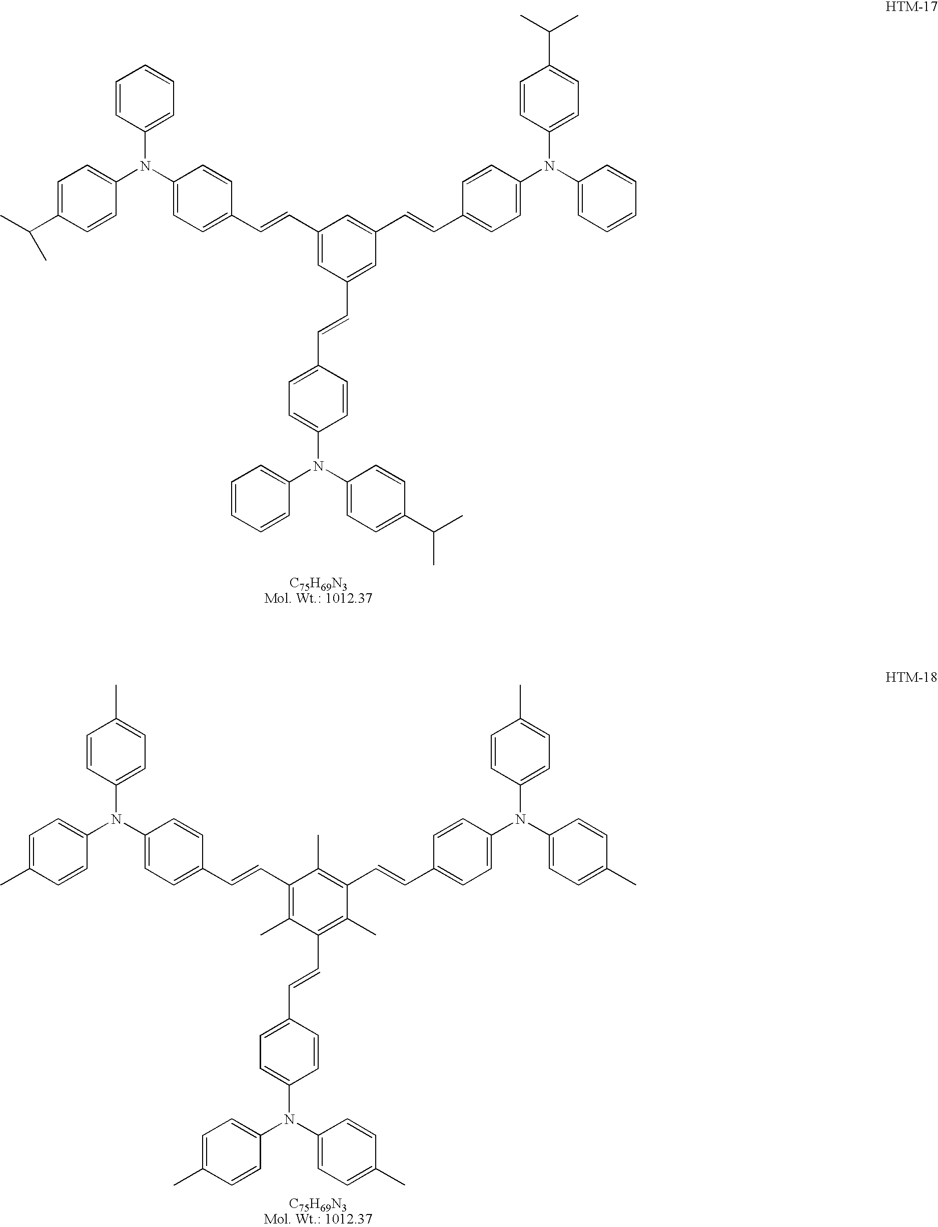 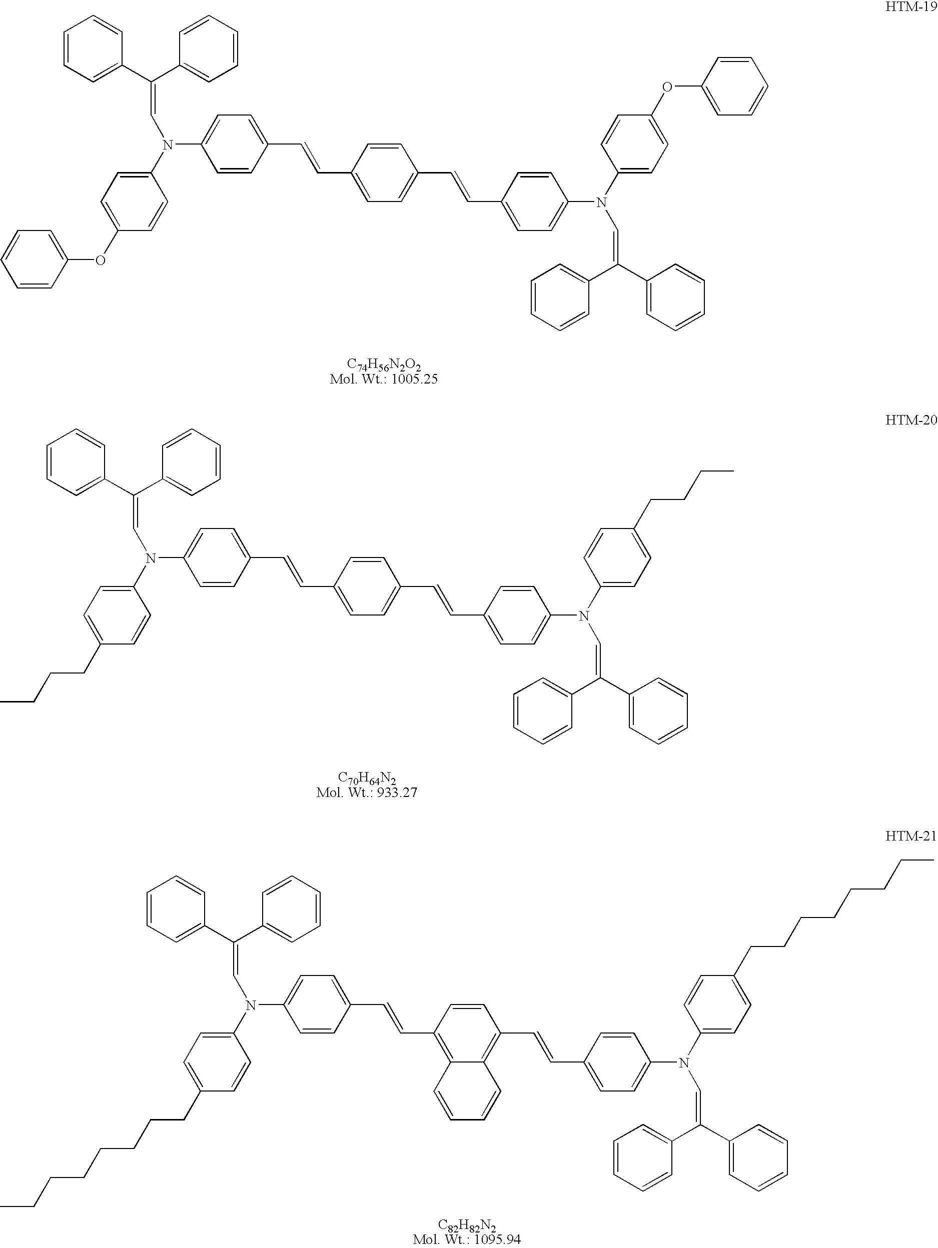 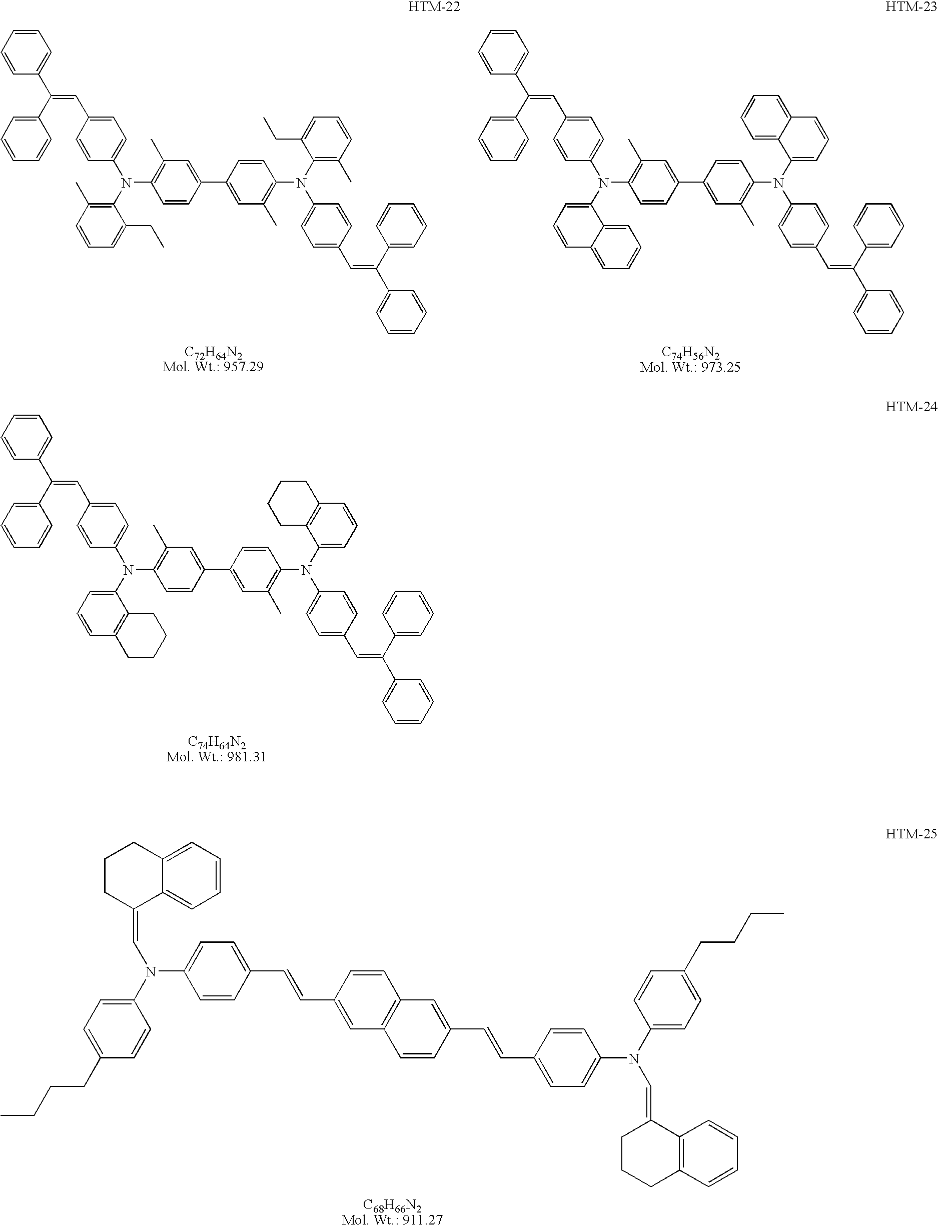 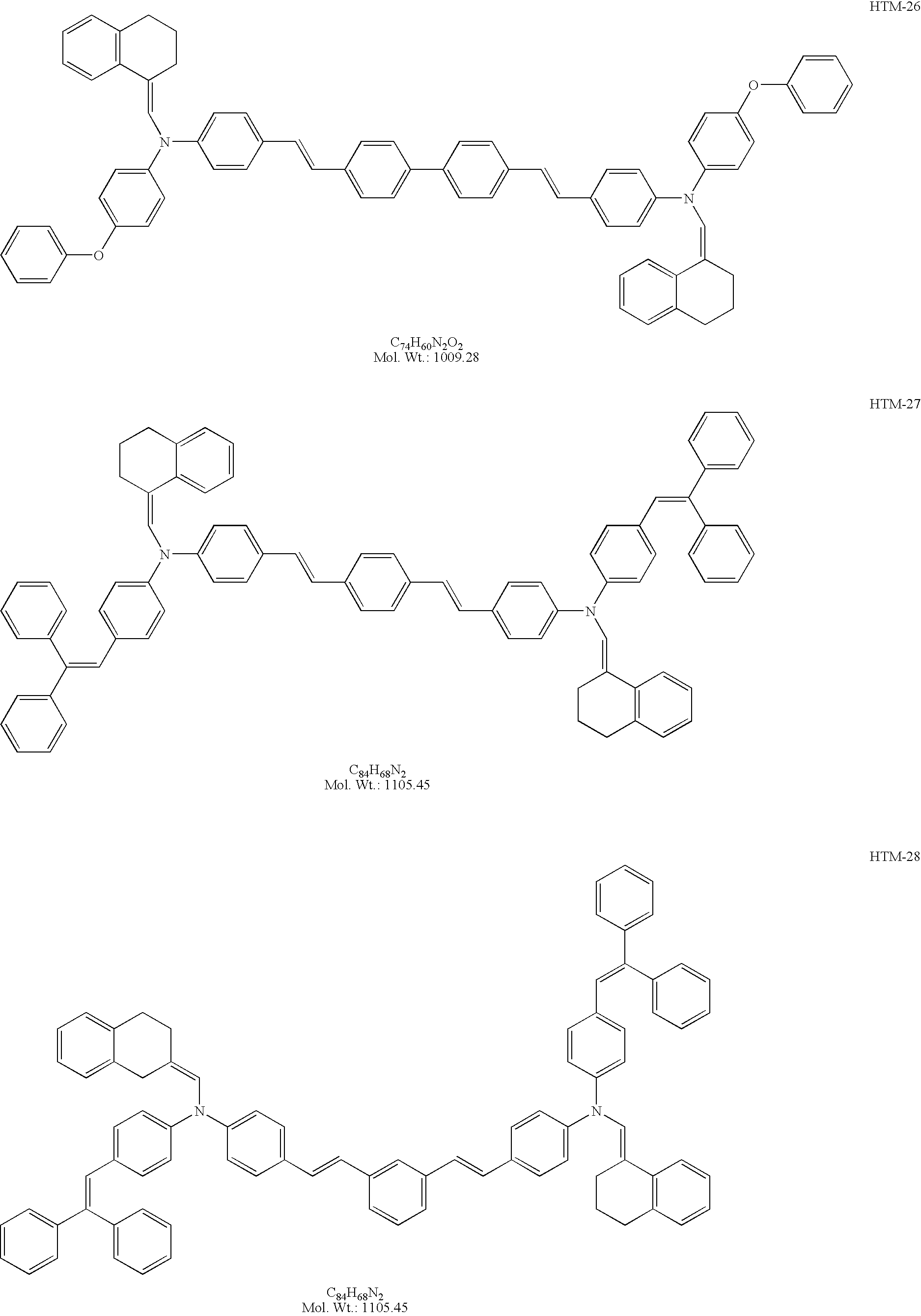 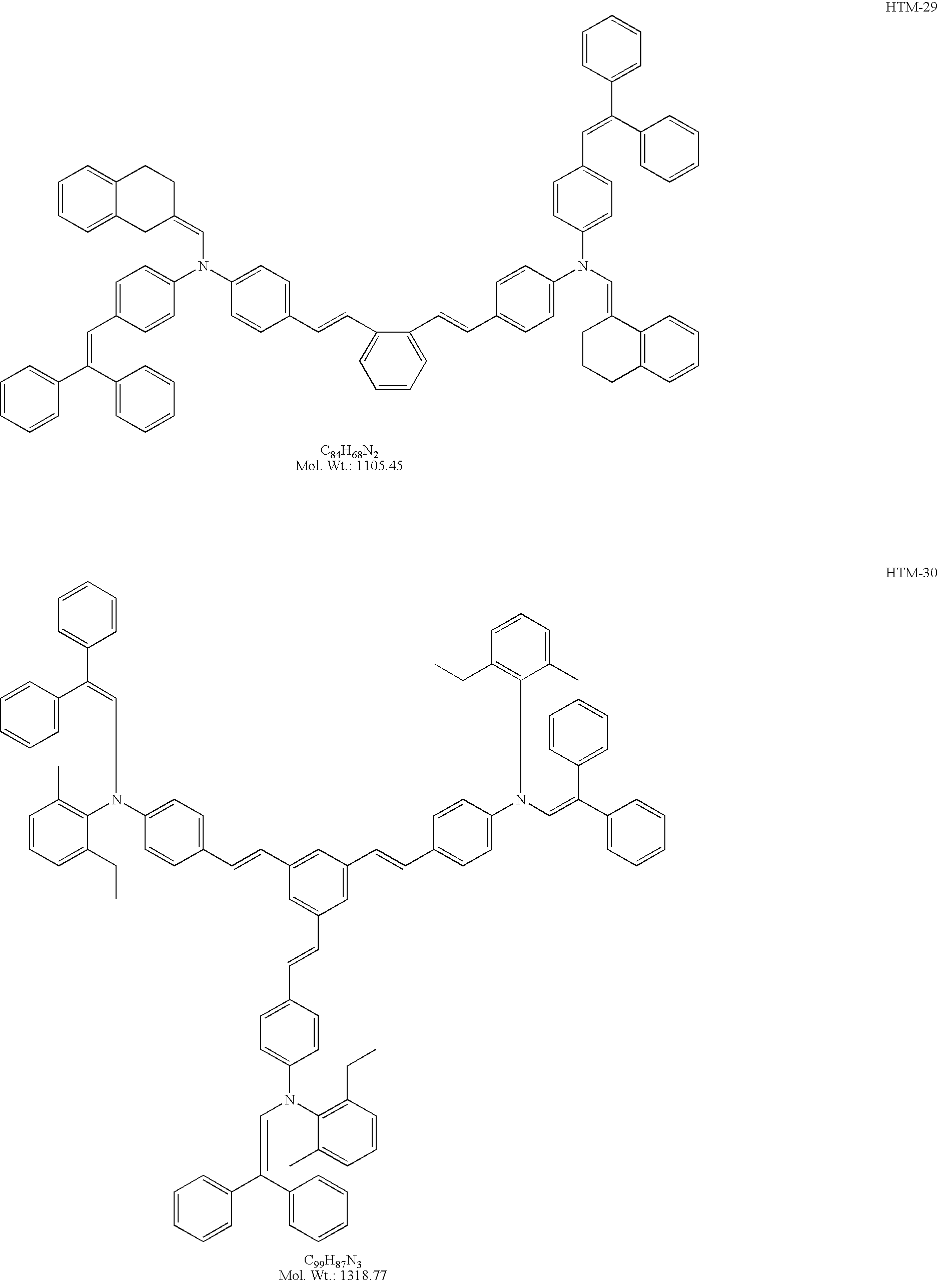 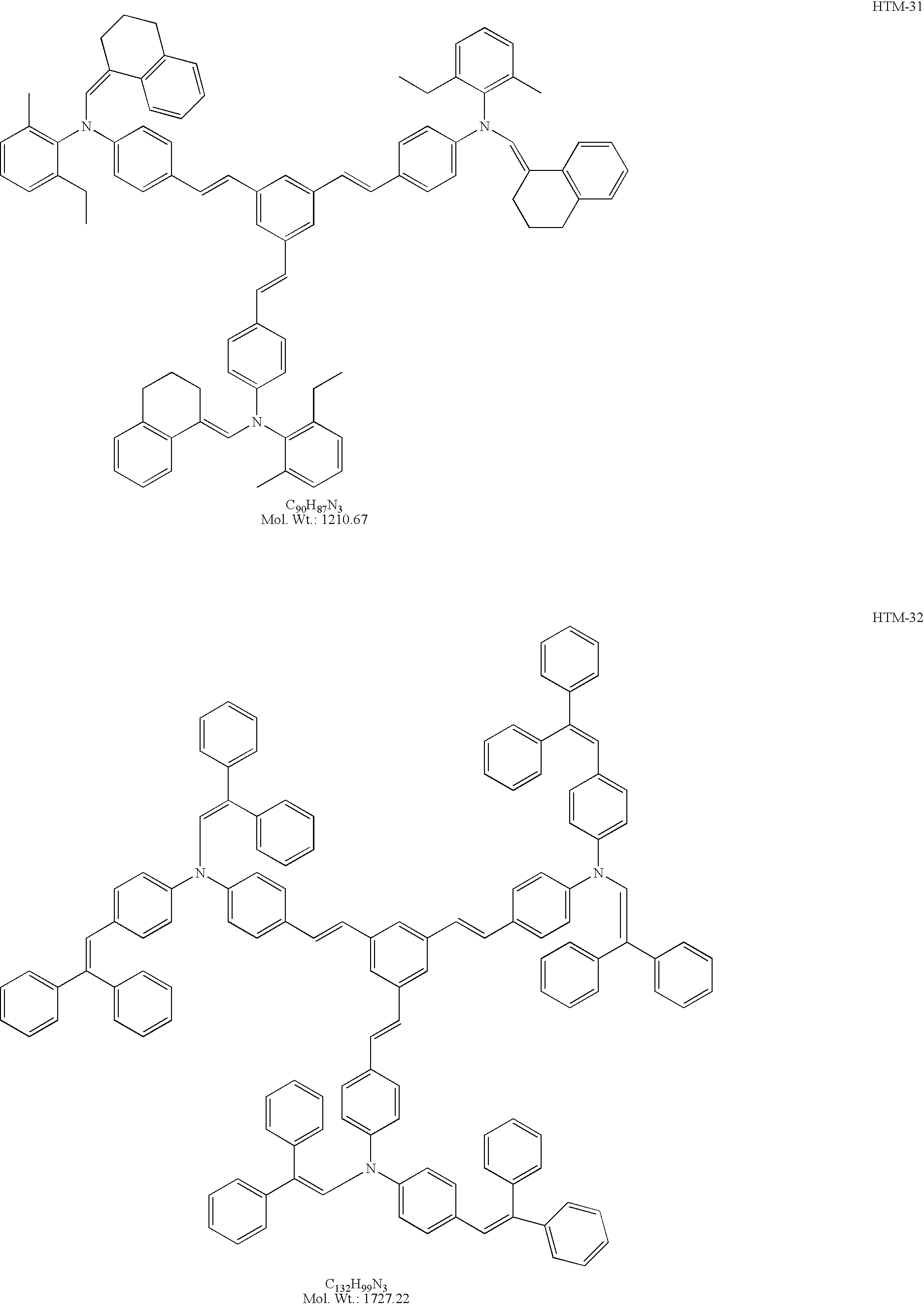 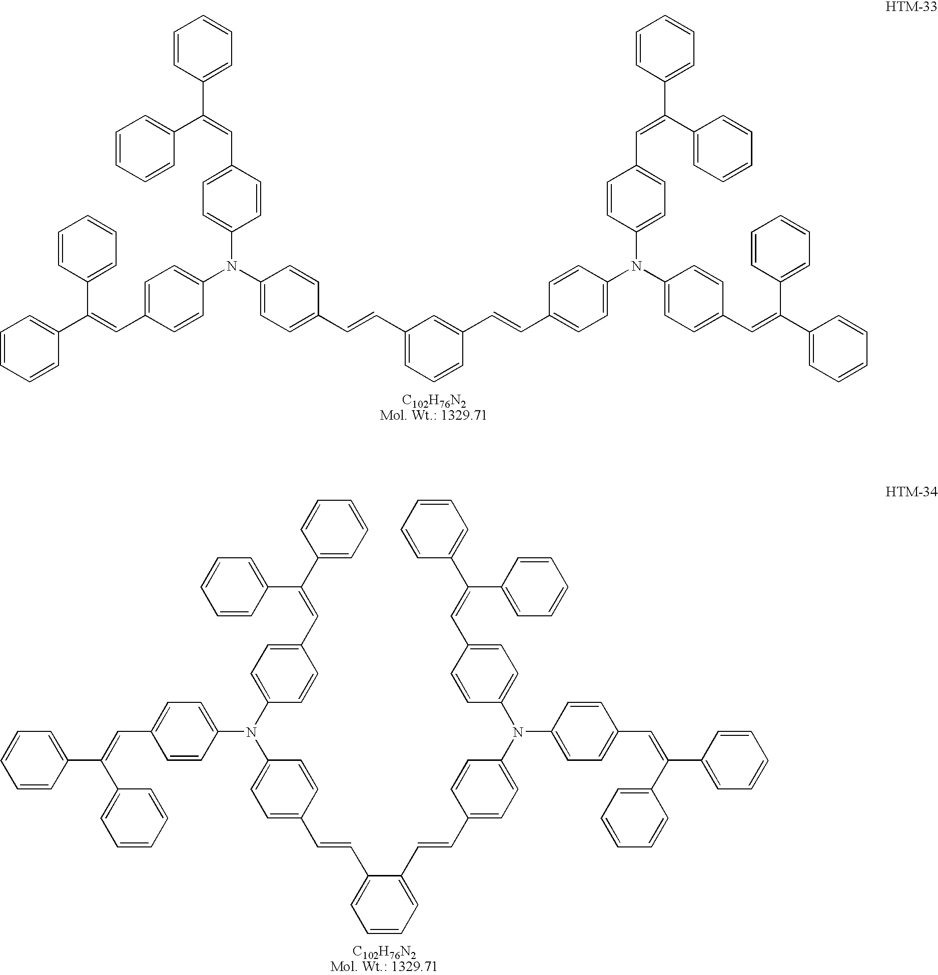 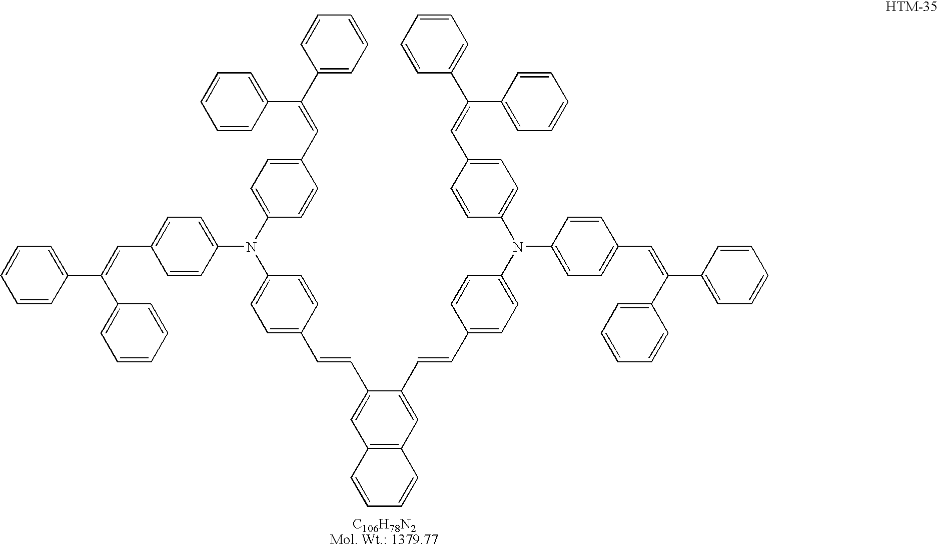
(5)-3 Amount of Addition

For constructing an electrophotographic photoconductor for wet developing, the amount of addition of the hole-transfer agent is preferably in the range of 10 to 80 parts by weight with respect to 100 parts by weight of a binder resin.

This is because, when the amount of the addition of the hole-transfer agent becomes less than 10 parts by weight, the sensitivity of the photoconductor decreases and thus any trouble may cause in practical use. On the other hand, when the amount of the addition of the hole-transfer agent exceeds 80 parts by weight, the hole-transfer agent tends to be crystallized and thus a proper film may be not formed as a photoconductor.

Therefore, it is more preferable that the amount of the addition of the electron-transfer agent is in the range of 30 to 70 parts by weight with respect to 100 parts by weight of the binder resin.

(5)-4 Elution Amount

For the amount of elution of the hole-transfer agent, furthermore, it is characterized that the amount of the elution of the hole-transfer agent after 2,000-hour-immersion in paraffin solvent having a kinematic viscosity (25° C., in accordance with ASTM D445) of 1.4 to 1.8 mm²/s is 0.040 g/m² or less.

This is because the solvent resistance, sensitivity characteristics and charging characteristics of the electrophotographic photoconductor for wet developing after long-term usage may be precisely estimated by limiting the amount of the hole-transfer agent eluted at 2,000 hours. Therefore, the solvent resistance, sensitivity characteristics and charging characteristics of the photoconductor, for example after carrying out image formation on 100,000 sheets of paper, may be also estimated by carrying out a 2,000-hour-immersion experiment under predetermined conditions.

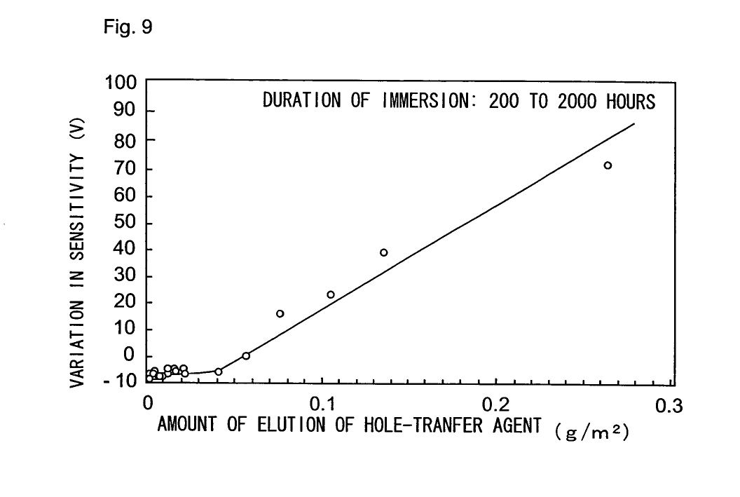

Here, referring now to FIG. 9, the relationship between the amount of elution of hole-transfer agent and the variations in sensitivity thereof will be described. In FIG. 9, variations in the amount of the elution of the hole-transfer agent (g/m²) after 200 to 2,000 hour immersion of an electrophotographic photoconductor for wet developing in solvent are plotted along the abscissa, while variations in sensitivity (V) of the electrophotographic photoconductor for wet developing are plotted along the ordinate.

From the characteristic diagram shown in FIG. 9, when the amount of the elution of the hole-transfer agent in paraffin solvent is 0.004 g/m² or less, variations in sensitivity (V) of the electrophotographic photoconductor for wet developing become extensively small. Thus, it is easily recognized that the difference between the initial sensitivity and the sensitivity after immersion of the photoconductor decreases.

However, when the amount of the elution of the hole-transfer agent after immersion thereof in paraffin solvent is extensively dropped, the range of choice for variety of the useable hole-transfer agents may be extensively narrowed.

Therefore, for example, the amount of the elution of the hole-transfer agent after 2,000-hour-immersion in paraffin solvent is adjusted within the range of 0.0001 to 0.030 g/m² so that variations in sensitivity (V) of the electrophotographic photoconductor for wet developing may be decreased more stably, while allowing the range of choice for the variety of the usable hole-transfer agent to be comparatively extended.

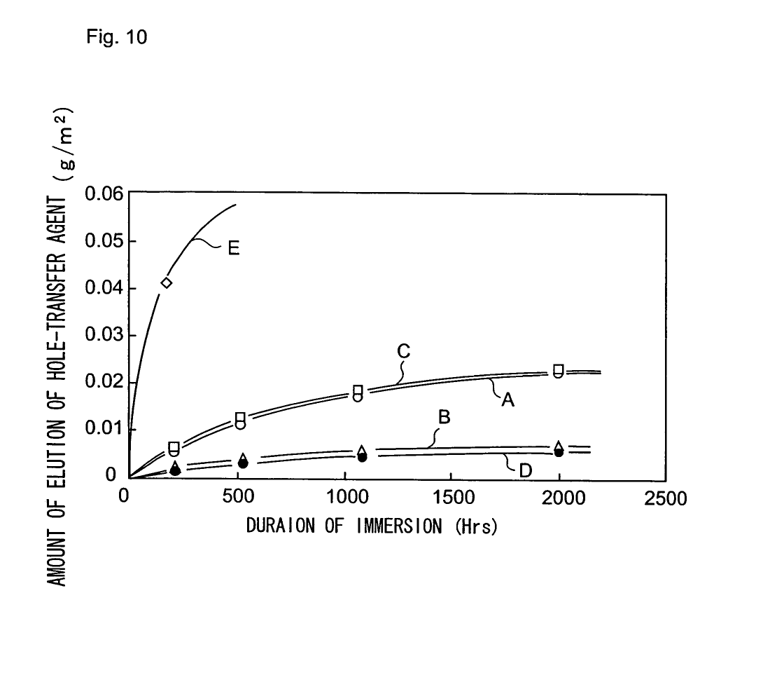

Next, referring now to FIG. 10, the relationship between the duration of immersion of an electrophotographic photoconductor for wet developing and the amount of the elution of the hole-transfer agent will be described.

In FIG. 10, variations in immersion time (Hrs) of the electrophotographic photoconductor for wet developing are plotted along the abscissa, while variations in amount of the hole-transfer agent eluted per unit area of the electrophotographic photoconductor for wet developing (g/m²) are plotted along the ordinate.

Furthermore, from several characteristic lines A to E (corresponding to Examples 1 to 4 and the Comparative Example 1) shown in FIG. 10, it is found that the amount of the elution of the hole-transfer agent eluted tends to be increased as far as the duration of immersion of the electrophotographic photoconductor for wet developing is extended. Concretely, it is easily recognized that an electrophotographic photoconductor for wet developing having a comparatively low amount of elution of a hole-transfer agent, examples of that are characteristic lines A and B, still have comparatively small amount of the elution of the hole-transfer agent even after extending time of immersion of about 2,000 hours.

That is, it may be estimated that solvent resistance and charging characteristics of an electrophotographic photoconductor for wet developing after long-term usage when the amount of elution of a hole-transfer agent after 200-hour-immersion in paraffin solvent is set to 0.018 g/m² or less.

However, when the amount of the elution of the hole-transfer agent is extensively small after 200-hour immersion in the paraffin solvent, the range of choice for variety of usable electron-transfer agents may be extensively small.

Therefore, by limiting the amount of the elution of the hole-transfer agent after 200-hour-immersion in the paraffin solvent within the range of 0.0001 to 0.010 g/m², variations in solvent resistance and charging characteristics of the electrophotographic photoconductor for wet developing after long-term usage may be estimated, and the range of choice for variety of the usable hole-transfer agents maybe comparatively extended.

Referring to FIG. 5, furthermore, the relationship between the kinematic viscosity of a paraffin solvent in which an electrophotographic photoconductor for wet developing to be immersed and the amount of elution of a hole-transfer agent will be described. That is, in FIG. 5, variations in kinematic viscosity (mm²/s) of the paraffin solvent in which the electrophotographic photoconductor for wet developing is immersed are plotted along the abscissa, while variations in the amount of the elution of the hole-transfer agent per unit area (g/m²) of the electrophotographic photoconductor for wet developing are plotted along the ordinate.

Furthermore, although it is depends on the kinds of the electrophotographic photoconductor for wet developing (A to E), it is recognized that lower kinematic viscosity of the paraffin solvent provides more amount of the elution of the hole-transfer agent.

In other words, using paraffin solvent having a kinematic viscosity (25° C., in accordance with ASTM D445) of 1.4 to 1.8 mm²/s permits the elution phenomenon of a hole-transfer agent to be tenderly reproduced. Therefore, variations in solvent resistance and charging characteristics of the electrophotographic photoconductor for wet developing may be precisely estimated after long-term usage thereof.

(5)-5 Molecular Weight

Furthermore, it is preferable that the molecular weight of the hole-transfer agent is 900 or more because of the following reasons: by designing the hole-transfer agent to have a molecular weight of 900 or more, the solvent resistance thereof to a hydrocarbon solvent may be improved to prevent the photoconductive layer from a decrease in sensitivity as well as effectively inhibit elution therefrom.

However, when the hole-transfer agent has an extensively large molecular weight, dispersing ability in the photoconductive layer or hole-transfer ability may decrease.

Therefore, the hole-transfer agent has a molecular weight of preferably in the range of 1,000 to 4,000, more preferably in the range of 1,000 to 2500.

Furthermore, the molecular weight of the hole-transfer agent may be calculated on the basis of its chemical formula using ChemDraw Standard Version 8 (manufactured by Cambridge Soft, Co., Ltd.) or may be calculated using a mass spectrum.

(6) Additives

Furthermore, in addition to each of ingredients described above, the composition of the photoconductor may be further blended with any of various additives well-known in the prior arts, including antidegradants such as oxidation inhibitors, radical scavengers, singlet quenchers and UV absorbers, or softeners, plasticizers, surface modifiers, augmentors, thickeners, dispersion stabilizers, waxes, acceptors, and donors. In addition, for improving the sensitivity of the photoconductive layer, any of sensitizers well-known in the prior arts such as terphenyl, halo-naphthoquinones and acenaphthylenes may be used together.

(7) Structure

Furthermore, in general, a photoconductive layer in a monolayer photoconductor has a thickness ranging from 5 to 100 μm, preferably ranging from 10 to 50 μm.

Examples of a conductive substrate on which such a photoconductive layer is formed may be prepared using various kinds of conductive materials, including metals such as iron, aluminum, copper, tin, platinum, silver, vanadium, molybdenum, chrome, cadmium, titanium, nickel, palladium, indium, stainless steel, and brass, plastic materials on which the metals are deposited or laminated, and glass materials coated with iodinated aluminum, tin oxide and indium oxide.

Furthermore, the conductive substrate may be formed into any of shapes such as a sheet or a drum so as to coordinate with the structure of an image-forming apparatus used as long as the conductive substrate itself or the surface thereof has conductivity. In addition, the conductive substrate may preferably have sufficient mechanical strength in use. When the photoconductive layer is formed by a dispersing method, the charge-generating agent, charge-transfer material, binder resin, and so on described above may be dispersed and mixed together with a suitable solvent using any of well-known techniques including a roll mill, a ball mill, an attritor, a paint shaker and an ultrasonic dispersing machine to thereby prepare a dispersion solution, followed by applying and drying the resultant solution using any of well-known procedures.

Furthermore, with respect to the configuration of the monolayer photoconductor, a barrier layer may be placed between the conductive substrate and the photoconductive layer as far as it does not inhibit the characteristic features of the photoconductor. Furthermore, a protective layer maybe formed on the surface of the photoconductor.

(8) Manufacturing Method

In a method of manufacturing an electrophotographic photoconductor of the invention, which is not particularly limited to, it is preferable to prepare a coating solution at first. Then, applying the resultant coating solution on a conductive substrate (aluminum tube) on the basis of any of manufacturing methods well-known in the prior arts, such as a dip-coating method. Subsequently, it was subjected to hot air drying at 100° C. for 30 minutes.

Consequently, an electrophotographic photoconductor having a photoconductive layer of a predetermined film thickness may be obtained. Here, a solvent for preparing such a dispersion solution may be any of various organic solvents including a group of alcohols such as methanol, ethanol, isopropanol and butanol; a group of aliphatic hydrocarbons such as n-hexane, octane and cyclohexane; a group of aromatic hydrocarbons such as benzene, toluene and xylene: a group of halogenated hydrocarbons such as dichloromethane, dichloroethane, chloroform, carbon tetrachloride and benzene chloride; a group of ethers such as dimethyl ether, diethyl ether, tetrahydrofuran, ethyleneglycol dimethylether, diethylenegrlycol dimethylether, 1,3-dioxiolane and 1,4-dioxan; a group of ketones such as acetone, methylethyl ketone and cyclohexanone; a group of esters such as ethyl acetate and methyl acetate; dimethyl formaldehyde, dimethyl formamide and dimethyl sulfoxide. These solvents may be used independently or in combination of two or more thereof.

Furthermore, for improving the dispersibility of charge-transfer and charge-generating agents and the smoothness of photoconductive layer surface, a surfactant, a leveling agent, or the like may be used.

2. Laminate Photoconductor

A laminate photoconductor may be produced by initially forming a charge-generating layer containing a charge-generating agent on a conductive substrate by a means such as vapor deposition or application, and then by applying a coating solution containing a hole-transfer agent, an electron-transfer agent and a binder resin on this conductive substrate, followed by drying to form a charge-transfer layer.

To the contrary, a laminate photoconductor may be also produced by initially forming the charge-transfer layer on the conductive substrate, on which the charge-generating layer is further formed. However, because the charge-generating layer has a very thin film thickness as compared to that of the charge-transfer layer, it is preferred for its protection to form the charge-generating layer on the conductive substrate and further form the charge-transfer layer thereon.

Incidentally, the description of the charge-generating agent, the hole-transfer agent, the electron-transfer agent, the binder and the like of the laminate photoconductor may be the same as the description for the monolayer photoconductor. However, in the case of the laminate photoconductor, it is preferable that the amount of addition of the charge-generating agent is within the range of 0.5 to 150 parts by weight with respect to 100 parts by weight of the binder resin constituting the charge-generating layer.

Moreover, charging type of the of the laminate photoconductor, positive or negative, is determined depending on the order of the formation of the above-described charge-generating layer and charge-transfer layer and the type of the charge-transfer material used in the charge-transfer layer. For example, the photoconductor is a negative charging type, when the charge-generating layer is formed on the conductive substrate, on which the charge-transfer layer is further formed, and the hole-transfer agent such as a stilbene derivative is used as the charge-transfer material in the charge-transfer layer. In this case, the charge-generating layer may contain the electron-transfer agent. Furthermore, the laminate electrophotographic photoconductor may be improved in sensitivity because the rest potential of the photoconductor is largely reduced.

For the thickness of the photoconductive layer in the laminate photoconductor, the charge-generating layer is approximately 0.01 to 5 μm, preferably approximately 0.1 to 3 μm in thickness, and the charge-transfer layer is approximately 2 to 100 μm, preferably approximately 5 to 50 μm in thickness.

[Second Embodiment]

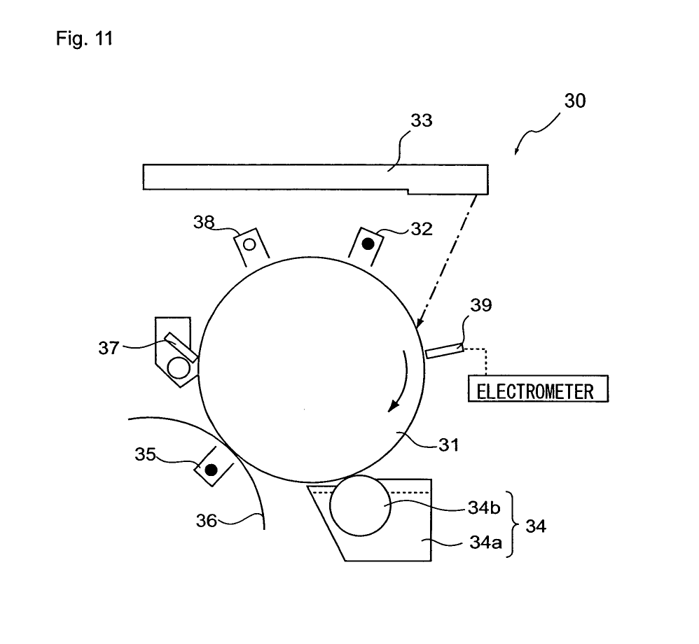

As shown in FIG. 11, a second embodiment of the invention is an image-forming apparatus for wet developing 30 having, in addition to an electrophotographic photoconductor for wet developing (hereinafter, also simply referred to as a “photoconductor”) 31 of the first embodiment, a charging device 32 for effecting a charging step, exposure light source 33 for effecting an exposure step, a wet developing device 34 for effecting a development step, and a transfer device 35 for effecting a transfer step arranged around the photoconductor 31, where a liquid developer 34a having toner dispersed in a hydrocarbon-based solvent is used to form images in the development step.

Incidentally, the image-forming apparatus for wet developing will be described below on the assumption that a monolayer photoconductor would be used as an electrophotographic photoconductor for wet developing.

The photoconductor 31 revolves at a constant speed in the direction as the arrow in the FIG. 11 shows and the electrophotographic process is carried out on the surface of the photoconductor 31 in the order presented below. More specifically, the photoconductor 31 is overall charged with the charging device 32 and print patterns are then exposed with the exposure light source 33. Subsequently, toner development is effected with the wet developing device 34 in response to the print patterns and the toner is then transferred to a transfer material (paper) 36 by the transfer device 35. Finally, redundant toner remaining in the photoconductor 31 is scraped off with a cleaning blade 37, and the electricity in the photoconductor 31 is eliminated with an electricity-eliminating light source 38.

Here, the liquid developer 34a having toner dispersed therein is transferred with a developing roller 34b. By applying a predetermined developing bias thereto, the toner is transferred onto the surface of the photoconductor 31 and developed on the photoconductor 31. Moreover, it is preferable that the concentration of a solid content in the liquid developer 34a is, for example, within the range of 5 to 25% by weight. Furthermore, a hydrocarbon-based solvent is preferably used as a liquid (toner-dispersing solvent) for use in the liquid developer 34a.

In addition, by defining the amount of elution of the hole-transfer agent or the electron-transfer agent after 2,000-hour-immersion in paraffin solvent having a predetermined kinematic viscosity to a predetermined amount or less in the photoconductor 31, a mono-layer electrophotographic photoconductor for wet developing excellent in solvent resistance and sensitivity characteristics may be obtained. Moreover, excellent image characteristics may be maintained in a long term. Namely, the electrophotographic photoconductor for wet developing may be stably produced. As a result, good solvent resistance and good images have been obtained.

### EXAMPLES

Hereinafter, the present invention will be described in detail with references to Examples and Comparative Examples.

### Example 1

(1) Production of Electrophotographic Photoconductor for Wet Developing

In an ultrasonic dispersing machine, 4 parts by weight of X-type metal-free phthalocyanine (CGM-1) that is one of compounds represented by the formula (3) as a charge-generating agent, 40 parts by weight of a stilbenamine derivative (HTM-1) that is one of compounds represented by the formula (19) as a hole-transfer agent, 40 parts by weight of a naphthoquinone derivative (ETM-1) that is one of compounds represented by the formula (8) as an electron-transfer agent, 100 parts by weight of a polycarbonate resin (Resin-1) with a viscosity average molecular weight of 50,000 represented by the formula (20) below as a binder resin, 0.1 parts by weight of KF-96-50CS (dimethylsilicone oil; Shin-Etsu Chemical) as a leveling agent, and 750 parts by weight of tetrahydrofuran as a solvent were accommodated, followed by mix and dispersion by 60-minute ultrasonic-treatment to produce a coating solution.

The resultant coating solution was applied on a conductive substrate (anodized-aluminum raw tube) having a diameter of 30 mm and a length of 254 mm by a dip-coating method. Then, the conductive substrate was subjected to hot-air drying for 20 minutes at the rate of heating of 5° C./minute from 30° C. to 130° C. and subsequently to hot-air drying on the condition of a temperature of 130° C. and a duration of 30 minutes to obtain an electrophotographic photoconductor for wet developing having a mono-layer photoconductive layer of 20 μm in film thickness.
Formula (20) 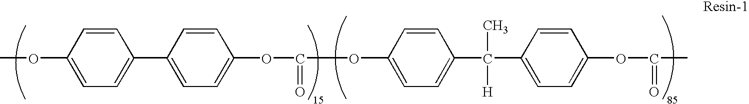
(2) Evaluation
(2)-1 Solvent Resistance Test

The resultant mono-layer electrophotographic photoconductor for wet developing was immersed in 500 cm³ of Isopar L (isoparaffin-based solvent; Exxon Chemicals; kinematic viscosity: 1.70 mm²/s, aromatic component content: 0.006% by weight) used as a developer in wet developing in the dark on the condition of a temperature of 25° C., a humidity of 60%, and a duration of 2,000 hours to measure the amount of elution of the hole-transfer agent and the electron-transfer agent per unit area in the electrophotographic photoconductor for wet developing, respectively.

It is noted that the amount of the elution of the hole-transfer agent per immersed area of the photoconductive layer in the obtained electrophotographic photoconductor for wet developing was calculated as follows.

At first, as the aluminum raw tube of the photoconductor has a diameter of 29.94 mm and the photoconductive layer has a thickness of 20 m, the diameter of the photoconductor is given by 29.94 mm+0.040 mm=29.98 mm. Next, as the length of the immersed portion of the photoconductor is 250.0 mm, the immersed area of the photoconductive layer is given by 0.250 m×(3.1416×0.02998 m)=0.023546 m².

Moreover, when the HTM-1 having a concentration of 5.0×10⁻⁶ g/cm³ was dissolved in the Isopar L solution, the absorbance for ultraviolet absorption peak wavelength (A max=420 nm) was 0.584. Subsequently, the photoconductor of Example 1 was immersed in the Isopar L solution for 2,000 hours, before the absorbance of the HTM-1 in the solution having the photoconductor immersed therein was measured and thus determined to be 0.108 (420 nm).

Accordingly, the amount of the elution of the HTM-1 was given by 0.108/0.584×(5.0×10⁻⁶ g/cm³)=9.24658×10⁻⁷ g/cm³, and the amount of the elution of the HTM-1 eluted per immersed area of the photoconductive layer was given by (9.24658×10⁻⁷ g/cm³×500 cm³)/0.023546 m²=0.0196 g/m².

In addition, the amount of elution of the electron-transfer agent per immersed area of the photoconductive layer in the obtained electrophotographic photoconductor for wet developing was calculated as follows.

At first, when the ETM-1 having a concentration of 5.0×10⁻⁶ g/cm³ was dissolved in the Isopar L solution, the absorbance for ultraviolet absorption peak wavelength (λmax=255 nm) was 0.400. Subsequently, the photoconductor of Example 1 was immersed in the Isopar L solution for 2,000 hours, before the absorbance of the ETM-1 in the solution having the photoconductor immersed therein was measured and thus determined to be 0.244 (255 nm) . Similarly, the absorbance of the HTM-1 was measured and thus determined to be 0.250 (255 nm).

Accordingly, the amount of the elution of the ETM-1 was given by [{0.244−0.250×(9.24658×10⁻⁷)/(5.0×10⁻⁶)}/0.400]×(5.0×10⁻⁶ g/cm³)=2.47209×10⁻⁶ g/cm³, and the amount of the elution of the ETM-1 per immersed area of the photoconductive layer was given by (2.47209×10⁻⁶ g/cm³×500 cm³)/0.023546 m²−0.0524949 g/m².

In the electrophotographic photoconductor for wet developing, an interface exists in the boundary between the coated region and the uncoated region of the photoconductive layer. However, when the solvent resistance test is carried out, the immersion of this interface of the photoconductive layer in the solvent may allow the hole-transfer agent, the electron-transfer agent, and the like, to be eluted in large amounts from the interface. As a result, the correct evaluation of the solvent resistance cannot be effected in some cases. Thus, when the solvent resistance test was effected, the interface was applied and protected with unburned PTFE tape (NICHIAS, NAFLON seal tape T/#9082) in which the unburned powder of PTFE (polytetrafluoroethylene) is formed into tape so that the solvent was not allowed to be immersed in this interface of the photoconductive layer.

(2)-2 Variation in Sensitivity

The sensitivity in the obtained electrophotographic photoconductor for wet developing was measured as follows. At first, using a drum sensitivity tester (GENTEC), the photoconductor was charged to 700 V. Subsequently, monochromatic light (half width: 20 nm, light quantity: 1.5 μJ/cm²) with a wavelength of 780 nm removed from the light of a halogen lamp with the use of a hand pulse filter was irradiated onto the surface of the photoconductor. Following irradiation, the potential after 330 msec post-irradiation was measured and used as initial sensitivity. Subsequently, the whole electrophotographic photoconductor for wet developing was immersed in Isopar L (aliphatic hydrocarbon-based solvent) in the dark on the condition of a temperature of 25° C., a humidity of 60%, and duration of 200 to 2,000 hours. Thereafter, the electrophotographic photoconductor for wet developing was removed from the Isopar L, and the sensitivity is measured in the same way to calculate the difference between the initial sensitivity and the post-immersion sensitivity after immersion, which was in turn used as a variation in sensitivity. The obtained result is shown in Table 2.

(2)-3 Variation in Repeat Characteristics

A variation in repeat characteristics in the obtained electrophotographic photoconductor for wet developing was measured as follows. At first, the potential was measured and used as an initial potential, with the photoconductor charged to 700 V using a drum sensitivity tester (GENTEC) . Subsequently, the whole electrophotographic photoconductor for wet developing was immersed in Isopar L (aliphatic hydrocarbon-based solvent) in the dark on the condition of a temperature of 25° C., a humidity of 60%, and duration of 200 to 2,000 hours. Thereafter, the electrophotographic photoconductor for wet developing was removed from the Isopar L and charged to 700 V. Subsequently, monochromatic light (half width: 20 nm, light quantity: 1.5 μJ/cm²) with a wavelength of 780 nm removed from the light of a halogen lamp with the use of a hand pulse filter was irradiated onto the surface of the photoconductor. Following irradiation, monochromatic light of 780 nm was further irradiated onto the whole surface of the photoconductor to eliminate electricity. This step of charging, exposure, and electricity elimination was carried out in 2400 cycles. The charged potential was then measured and used as a post-running charged potential. The difference between the initial charged potential and the post-running charged potential was calculated and used as a variation in repeat characteristics. The obtained result is shown in table 2.

(2)-4 Evaluation of Appearance

Moreover, the appearance of the electrophotographic photoconductor for wet developing after the evaluation of solvent resistance (2,000-hour-immersion) was visually observed to effect the evaluation of appearance in conformance with the criteria described below. The obtained result is shown in Table 1.
Excellent: No change in appearance is observed.
Good: No remarkable change in appearance is observed.
Poor: A little change in appearance is observed.
Very poor: Remarkable change in appearance is observed.

### Examples 2 to 10 and Comparative Examples 1 to 3

In Examples 2 to 10, mono-layer electrophotographic photoconductors for wet developing were produced and evaluated in the same way as in Example 1, except that hole-transfer agents represented by the formula (19), electron-transfer agents represented by the formula (8) and binder resins represented by the formula (23) below, as shown in Table 1, were respectively used.

Alternatively, in Comparative Examples 1 to 3, mono-layer electrophotographic photoconductors for wet developing were produced and evaluated in the same way as in Example 1, except that an amine compound (HTM-36) represented by the formula (21) below, electron-transfer agents (ETM-10 and -11) represented by the formula (22) below and binder resins (Resin-2 to -5) represented by the formula (23) below were used. The viscosity average molecular weights of the binder resins (Resin-2 to -5) represented by the formula (23) are 50,200, 50,100, 50,000 and 50,000, respectively.

It is noted that all or part of evaluations in the duration of immersion of 2,000 hours were discontinued in Comparative Examples 2 and 3 because the amount of elution of the hole-transfer agents and the electron-transfer agents was remarkably large and, if the duration of immersion of the electrophotographic photoconductors for wet developing was long, it was difficult to keep their configuration.

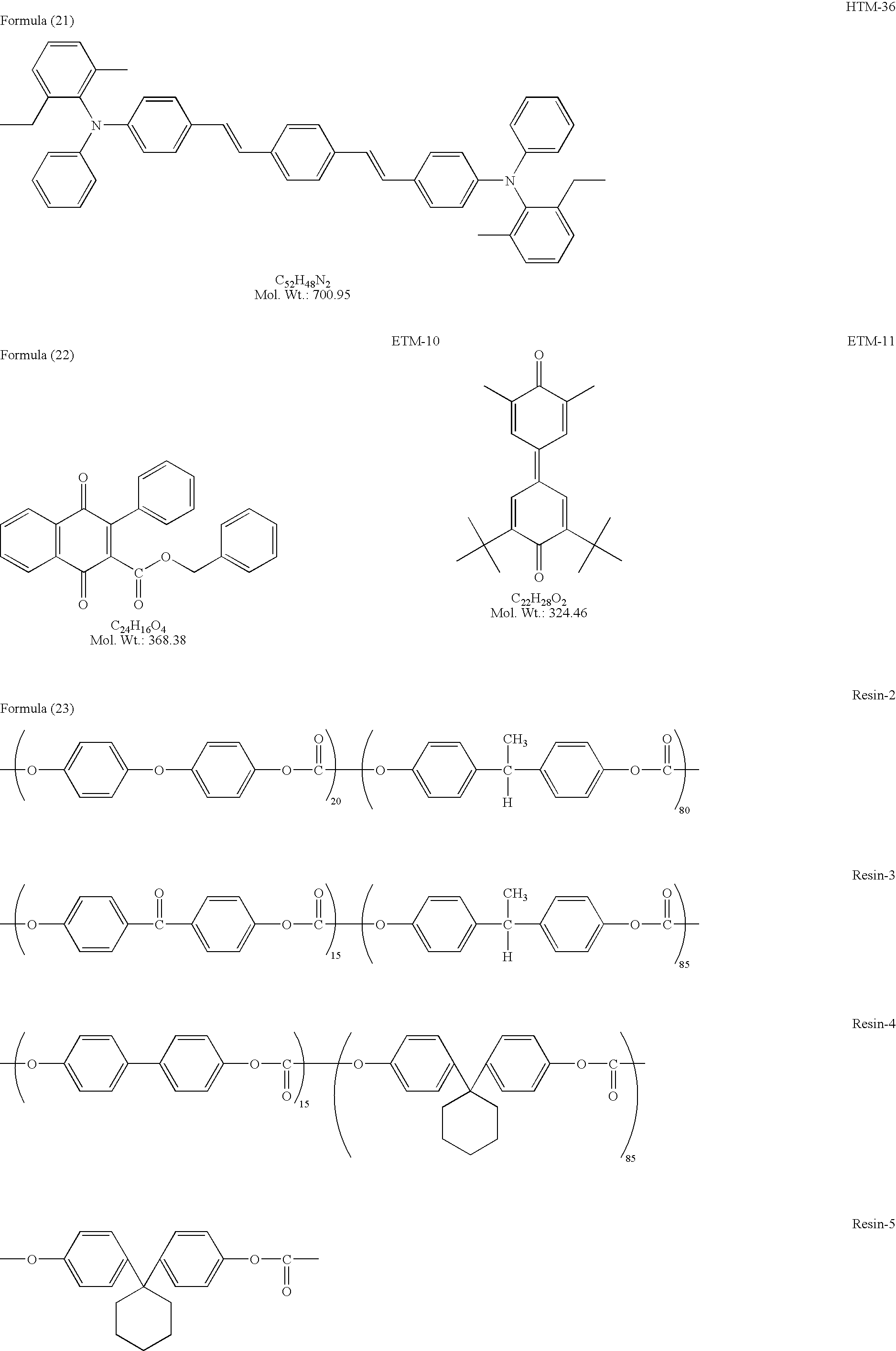

TABLE 1

| | Binder | Hole-transfer | Electron- | Change in |
|---|---|---|---|---|
| | resin | agent | transfer agent | appearance |
| Example 1 | Resin-1 | HTM-1 | ETM-1 | Excellent |
| Example 2 | | HTM-2 | | Excellent |
| Example 3 | | HTM-1 | ETM-2 | Excellent |
| Example 4 | | HTM-2 | | Excellent |
| Example 5 | | HTM-3 | | Excellent |
| Example 6 | | HTM-4 | | Excellent |
| Example 7 | | HTM-5 | | Excellent |
| Example 8 | | HTM-1 | ETM-3 | Excellent |
| Example 9 | Resin-2 | | ETM-2 | Excellent |
| Example 10 | Resin-3 | | | Excellent |
| Comparative | Resin-1 | HTM-37 | ETM-10 | Very poor |
| Example 1 | | | | |
| Comparative | Resin-4 | | | Very poor |
| Example 2 | | | | |
| Comparative | Resin-5 | | ETM-11 | Very poor |
| Example 3 | | | | |

TABLE 2

| | After 200-hour-immersion | | | | After 2000-hour-immersion | | | |
|---|---|---|---|---|---|---|---|---|
| | | | Variation | Variation | | | Variation | Variation |
| | | | in | in repeat | | | in | in repeat |
| | HTM | ETM | sensitivity | characteristics | HTM | ETM | sensitivity | characteristics |
| | (g/m²) | (g/m²) | (V) | (V) | (g/m²) | (g/m²) | (V) | (V) |
| Ex. 1 | 0.0051 | 0.0216 | 3 | 0 | 0.0196 | 0.0525 | 4 | −8 |
| Ex. 2 | 0.0025 | 0.0205 | 2 | −1 | 0.0095 | 0.0510 | 1 | −8 |
| Ex. 3 | 0.0055 | 0.0045 | 1 | −1 | 0.0220 | 0.0156 | 2 | 0 |
| Ex. 4 | 0.0019 | 0.0044 | 0 | 0 | 0.0084 | 0.0150 | 1 | 0 |
| Ex. 5 | 0.0052 | 0.0046 | −1 | 1 | 0.0221 | 0.0162 | 2 | −5 |
| Ex. 6 | 0.0070 | 0.0047 | 2 | −1 | 0.0269 | 0.0211 | 4 | −6 |
| Ex. 7 | 0.0091 | 0.0051 | 1 | −1 | 0.0284 | 0.0243 | 5 | −4 |
| Ex. 8 | 0.0055 | 0.0045 | 0 | 1 | 0.0220 | 0.0156 | 3 | −2 |
| Ex. 9 | 0.0050 | 0.0045 | 0 | 1 | 0.0210 | 0.0159 | 2 | −2 |
| Ex. 10 | 0.0041 | 0.0043 | 0 | 1 | 0.0189 | 0.0136 | 3 | −2 |
| C.E. 1 | 0.0411 | 0.0812 | 4 | −8 | 0.1356 | 0.4248 | 49 | −68 |

| | | | | | | | |
|---|---|---|---|---|---|---|---|
| C.E. 2 | 0.1056 | 0.6254 | 32 | −86 | 2.1254 | 10.546 | Evaluation |
| | | | | | | | discontinued |

| | | | | | |
|---|---|---|---|---|---|
| C.E. 3 | 1.2540 | 8.1240 | 591 | −422 | Evaluation discontinued |

*HTM: the amount of the elution of the hole-transfer agent.
*ETM: the amount of the elution of the electron-transfer agent.
Ex.: Example
C.E.: Comparative Example

### Examples 11 to 22

In Examples 11 to 22, the mono-layer electrophotographic photoconductors for wet developing obtained in Examples 1 to 4 were used, and Isopar G, Isopar H and Norpar 12 were respectively used instead of Isopar L used as a developer in wet developing to evaluate solvent resistance test and a variation in sensitivity described above, respectively. The obtained results each were shown in Table 3.

### Comparative Examples 4 to 8

In Comparative Examples 4 to 8, the mono-layer electrophotographic photoconductor for wet developing obtained in Comparative Examples 1 was used, and Isopar G, Isopar H, Norpar 12, Norpar 15 and Isopar M were respectively used instead of Isopar L used as a developer in wet developing to evaluate solvent resistance test and a variation in sensitivity described above, respectively. The obtained results each were shown in Table 3.

### Comparative Examples 9 to 16

In Comparative Examples 9 to 16, the mono-layer electrophotographic photoconductors for wet developing obtained in Examples 1 to 4 were used, and Norpar 15 and Isopar M were respectively used instead of Isopar L used as a developer in wet developing to evaluate solvent resistance test and a variation in sensitivity described above, respectively. The obtained results each were shown in Table 3.

TABLE 3

| | | Solvent | | | | | | | | | |
|---|---|---|---|---|---|---|---|---|---|---|---|
| | | | Content | | | | | | | | |
| | | | of | | | | | After 2,000-hour- | | | Variation |
| | Configuration | | aromatic | Kinematic | Initial | | | immersion | | | in |
| | of | | series | viscosity | Sensitivity | HTM | ETM | Sensitivity | HTM | ETM | sensitivity |
| | photoconductor | Type | (wt %) | (mm2/s) | (V) | (g/m2) | (g/m2) | (V) | (g/m2) | (g/m2) | (V) |
| Ex. 11 | Ex. 1 | Isopar G | 0.002 | 1.46 | 120 | 0 | 0 | 126 | 0.0225 | 0.0524 | 6 |
| Ex. 12 | Ex. 2 | | | | 118 | 0 | 0 | 119 | 0.0149 | 0.0459 | 1 |
| Ex. 13 | Ex. 3 | | | | 125 | 0 | 0 | 128 | 0.0310 | 0.0141 | 3 |
| Ex. 14 | Ex. 4 | | | | 120 | 0 | 0 | 120 | 0.0100 | 0.0170 | 0 |
| Ex. 15 | Ex. 1 | Isopar H | 0.01 | 1.80 | 120 | 0 | 0 | 125 | 0.0198 | 0.0509 | 5 |
| Ex. 16 | Ex. 2 | | | | 118 | 0 | 0 | 118 | 0.0087 | 0.0482 | 0 |
| Ex. 17 | Ex. 3 | | | | 125 | 0 | 0 | 127 | 0.0210 | 0.0154 | 2 |
| Ex. 18 | Ex. 4 | | | | 120 | 0 | 0 | 121 | 0.0080 | 0.0150 | 1 |
| Ex. 19 | Ex. 1 | Norpar | 0.01 | 1.63 | 120 | 0 | 0 | 122 | 0.0251 | 0.0564 | 2 |
| Ex. 20 | Ex. 2 | 12 | | | 118 | 0 | 0 | 119 | 0.0131 | 0.0502 | 1 |
| Ex. 21 | Ex. 3 | | | | 125 | 0 | 0 | 127 | 0.0360 | 0.0190 | 2 |
| Ex. 22 | Ex. 4 | | | | 120 | 0 | 0 | 121 | 0.0090 | 0.0140 | 1 |
| C.E. 4 | C.E. 1 | Isopar G | 0.002 | 1.46 | 123 | 0 | 0 | 201 | 0.2245 | 0.6243 | 78 |
| C.E. 5 | | Isopar H | 0.01 | 1.80 | 123 | 0 | 0 | 170 | 0.1350 | 0.4312 | 47 |
| C.E. 6 | | Norpar | 0.01 | 1.63 | 123 | 0 | 0 | 199 | 0.2314 | 0.5144 | 76 |
| | | 12 | | | | | | | | | |
| C.E. 7 | | Norpar | 0.01 | 3.27 | 123 | 0 | 0 | 145 | 0.0672 | 0.2100 | 22 |
| | | 15 | | | | | | | | | |
| C.E. 8 | | Isopar M | 0.025 | 3.80 | 123 | 0 | 0 | 139 | 0.0510 | 0.1940 | 16 |
| C.E. 9 | Ex. 1 | Norpar | 0.01 | 3.27 | 120 | 0 | 0 | 121 | 0.0145 | 0.0453 | 1 |
| C.E. 10 | Ex. 2 | 15 | | | 118 | 0 | 0 | 120 | 0.0085 | 0.0419 | 2 |
| C.E. 11 | Ex. 3 | | | | 125 | 0 | 0 | 125 | 0.0170 | 0.0130 | 0 |
| C.E. 12 | Ex. 4 | | | | 120 | 0 | 0 | 120 | 0.0060 | 0.0100 | 0 |
| C.E. 13 | Ex. 1 | Isopar M | 0.025 | 3.80 | 120 | 0 | 0 | 121 | 0.0099 | 0.0402 | 1 |
| C.E. 14 | Ex. 2 | | | | 118 | 0 | 0 | 117 | 0.0090 | 0.0426 | −1 |
| C.E. 15 | Ex. 3 | | | | 125 | 0 | 0 | 125 | 0.0130 | 0.0120 | 0 |
| C.E. 16 | Ex. 4 | | | | 120 | 0 | 0 | 121 | 0.0050 | 0.0100 | 1 |

*HTM: the amount of the elution of the hole-transfer agent
*ETM: the amount of the elution of the electron-transfer agent
Ex.: Exampel
C.E.: Comparative Example

### Examples 23 to 38, Comparative Example 17

In Examples 23 to 38 and Comparative Example 17, mono-layer electrophotographic photoconductors for wet developing were produced in the same way as in Example 1, except that hole-transfer agents represented by the formulas (19) and (24), electron-transfer agents represented by the formulas (8) and (25) and binder resins represented by the following formula (26), as shown in Table 4, were respectively used, and the amount of addition of the electron-transfer agent was changed to 50 parts by weight. Moreover, evaluation was carried out in the same way as in Example 1, except that solvent resistance test and a variation in sensitivity were evaluated only in the duration of immersion in a hydrocarbon-based solvent of 2,000 hours. The viscosity average molecular weights of the polycarbonate resins (Resin-6 to -10) represented by the formula (26) are 50,200, 50,100, 50,300, 50,100, and 50,000, respectively.

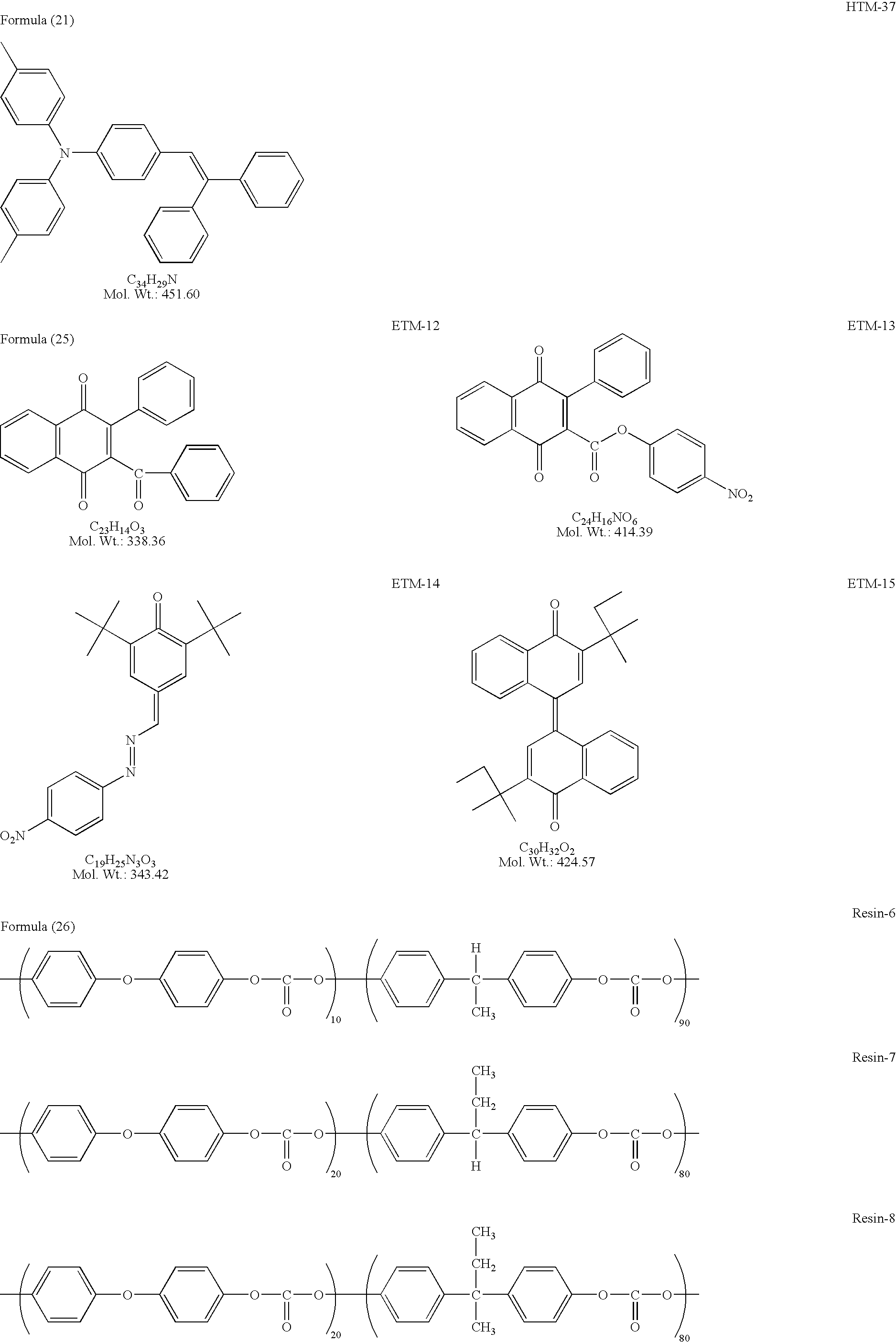

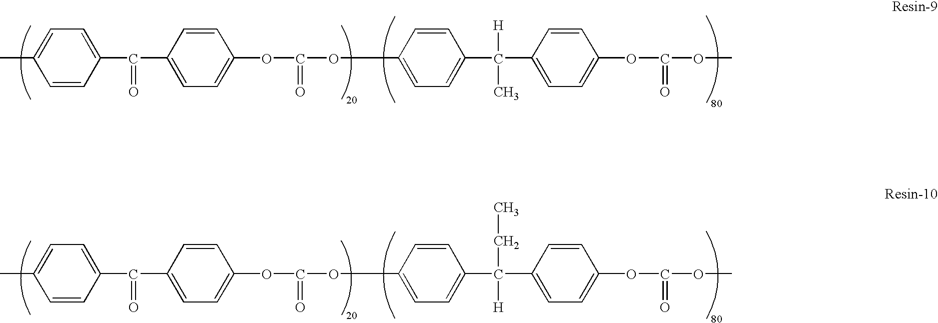

TABLE 4

| | | | Hole-transfer | | | | | Variation | |
|---|---|---|---|---|---|---|---|---|---|
| | | Charge- | agent | | Electron- | | Initial | in | |
| | Binder | generation | | Molecular | transfer | HTM | sensitivity | sensitivity | Change in |
| | resin | agent | Type | weight | agent | (g/m2) | (V) | (V) | appearance |
| Ex. 23 | Resin-6 | CGM-1 | HTM-15 | 1462.90 | ETM-12 | 0.0046 | 99 | 2 | Excellent |
| Ex. 24 | | | | 1462.90 | ETM-13 | 0.0024 | 95 | 1 | Excellent |
| Ex. 25 | | | | 1462.90 | ETM-2 | 0.0023 | 97 | 0 | Excellent |
| Ex. 26 | | | | 1462.90 | ETM-14 | 0.0145 | 97 | 5 | Excellent |
| Ex. 27 | | | | 1462.90 | ETM-15 | 0.0186 | 94 | 9 | Good |
| Ex. 28 | | | HTM-16 | 1012.37 | ETM-12 | 0.0132 | 119 | 4 | Good |
| Ex. 29 | | CGM-2 | | 1012.37 | | 0.0130 | 116 | 4 | Good |
| Ex. 30 | | CGM-3 | | 1012.37 | | 0.0139 | 109 | 5 | Good |
| Ex. 31 | | CGM-4 | | 1012.37 | | 0.0133 | 112 | 3 | Good |
| Ex. 32 | | CGM-1 | HTM-17 | 1012.37 | | 0.0127 | 108 | 2 | Good |
| Ex. 33 | | | HTM-18 | 1012.37 | | 0.0129 | 105 | 4 | Good |
| Ex. 34 | Resin-7 | | HTM-15 | 1462.90 | | 0.0092 | 100 | 4 | Excellent |
| Ex. 35 | Resin-8 | | | 1462.90 | | 0.0160 | 100 | 7 | Good |
| Ex. 36 | Resin-9 | | | 1462.90 | | 0.0039 | 105 | 1 | Excellent |
| Ex. 37 | Resin-10 | | | 1462.90 | | 0.0041 | 104 | 1 | Excellent |
| Ex. 38 | Resin-8 | | | 1462.90 | ETM-15 | 0.0323 | 95 | 24 | Poor |
| C.E. 17 | Resin-6 | | HTM-37 | 451.60 | ETM-12 | 0.0958 | 104 | 88 | Very poor |

*HTM: the amount of the elution of the hole-transfer agent.
Ex.: Example
C.E.: Comparative Example

### Examples 39 to 60, Comparative Example 18

In Examples 39 to 60 and Comparative Example 18, mono-layer electrophotographic photoconductors for wet developing were produced in the same way as in Example 1, except that hole-transfer agents represented by the formulas (19) and (27), electron-transfer agents represented by the formulas (8) and (25), binder resins represented by the formulas (20) and (26) and charge-generating agents represented by the formula (3), as shown in Table 5, were respectively used, and the amount of addition of the electron-transfer agent was changed to 50 parts by weight. Moreover, evaluation was carried out in the same way as in Example 1, except that solvent resistance test and a variation in sensitivity were evaluated only in the duration of immersion in a hydrocarbon-based solvent of 2,000 hours, and Isopar G was used as a hydrocarbon-based solvent instead of Isopar L. The obtained results each are shown in Table 5.

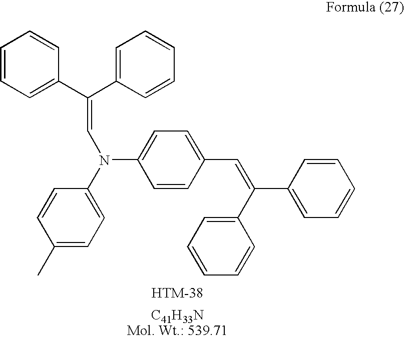

TABLE 5

| | | | Hole-transfer | | | | | Variation | |
|---|---|---|---|---|---|---|---|---|---|
| | | Charge- | agent | | Electron- | | Initial | in | |
| | Binder | generating | | Molecular | transfer | HTM | sensitivity | sensitivity | Change in |
| | resin | agent | Type | weight | agent | (g/m2) | (V) | (V) | appearance |
| Ex. 39 | Resin-1 | CGM-1 | HTM-10 | 1177.52 | ETM-12 | 0.0070 | 104 | 1 | Excellent |
| Ex. 40 | | CGM-2 | | | | 0.0075 | 100 | 3 | Excellent |
| Ex. 41 | | CGM-3 | | | | 0.0066 | 98 | 1 | Excellent |
| Ex. 42 | | CGM-4 | | | | 0.0073 | 96 | 0 | Excellent |
| Ex. 43 | | CGM-1 | HTM-11 | 1227.58 | | 0.0057 | 110 | 0 | Excellent |
| Ex. 44 | | | HTM-12 | 1245.63 | | 0.0063 | 103 | 2 | Excellent |
| Ex. 45 | | | HTM-10 | 1177.52 | ETM-13 | 0.0034 | 110 | 1 | Excellent |
| Ex. 46 | | | | | ETM-2 | 0.0033 | 108 | 0 | Excellent |
| Ex. 47 | | | | | ETM-14 | 0.0149 | 95 | 5 | Good |
| Ex. 48 | | | HTM-13 | 1177.52 | ETM-12 | 0.0070 | 113 | 2 | Excellent |
| Ex. 49 | | | HTM-14 | 1177.52 | | 0.0068 | 112 | 1 | Excellent |
| Ex. 50 | Resin-6 | CGM-1 | HTM-19 | 1005.25 | ETM-12 | 0.0106 | 107 | 2 | Excellent |
| Ex. 51 | | CGM-2 | | | | 0.0109 | 106 | 2 | Excellent |
| Ex. 52 | | CGM-3 | | | | 0.0105 | 99 | 2 | Excellent |
| Ex. 53 | | CGM-4 | | | | 0.0111 | 100 | 3 | Excellent |
| Ex. 54 | | CGM-1 | HTM-20 | 933.27 | | 0.0142 | 105 | 4 | Excellent |
| Ex. 55 | | | HTM-21 | 1095.54 | | 0.0101 | 119 | 1 | Excellent |
| Ex. 56 | | | HTM-19 | 1005.25 | ETM-13 | 0.0071 | 107 | 1 | Excellent |
| Ex. 57 | | | | | ETM-2 | 0.0067 | 109 | 0 | Excellent |
| Ex. 58 | | | | | ETM-14 | 0.0180 | 105 | 5 | Good |
| Ex. 59 | | | HTM-20 | 933.27 | | 0.0190 | 105 | 6 | Good |
| Ex. 60 | | | HTM-21 | 1095.54 | | 0.0179 | 103 | 5 | Good |
| C.E. 18 | Resin-6 | CGM-1 | HTM-38 | 539.71 | ETM-12 | 0.0544 | 105 | 44 | Very poor |

*HTM: the amount of the elution of the hole-transfer agent.
Ex.: Example
C.E.: Comparative Example

### Examples 61 to 75, Comparative Examples 19 to 21

In Examples 61 to 75 and Comparative Examples 19 to 21, mono-layer electrophotographic photoconductors for wet developing were produced in the same way as in Example 1, except that hole-transfer agents represented by the formulas (19), (24) and (30), electron-transfer agents represented by the formulas (8), (25) and (28), binder resins represented by the formulas (20), (23) and (29) and charge-generating agents represented by the formula (3), as shown in Table 6, were respectively used, and the amount of addition of the electron-transfer agent was changed to 50 parts by weight. Moreover, evaluation was carried out in the same way as in Example 1, except that solvent resistance test and a variation in sensitivity were evaluated only in the duration of immersion in a hydrocarbon-based solvent of 2,000 hours, and Norpar 12 was used as a hydrocarbon-based solvent instead of Isopar L. The obtained results each are shown in Table 6.

Incidentally, the viscosity average molecular weight of the polycarbonate resins (Resin-11 to -12) represented by the formula (29) are 50,000 and 50,100, respectively.

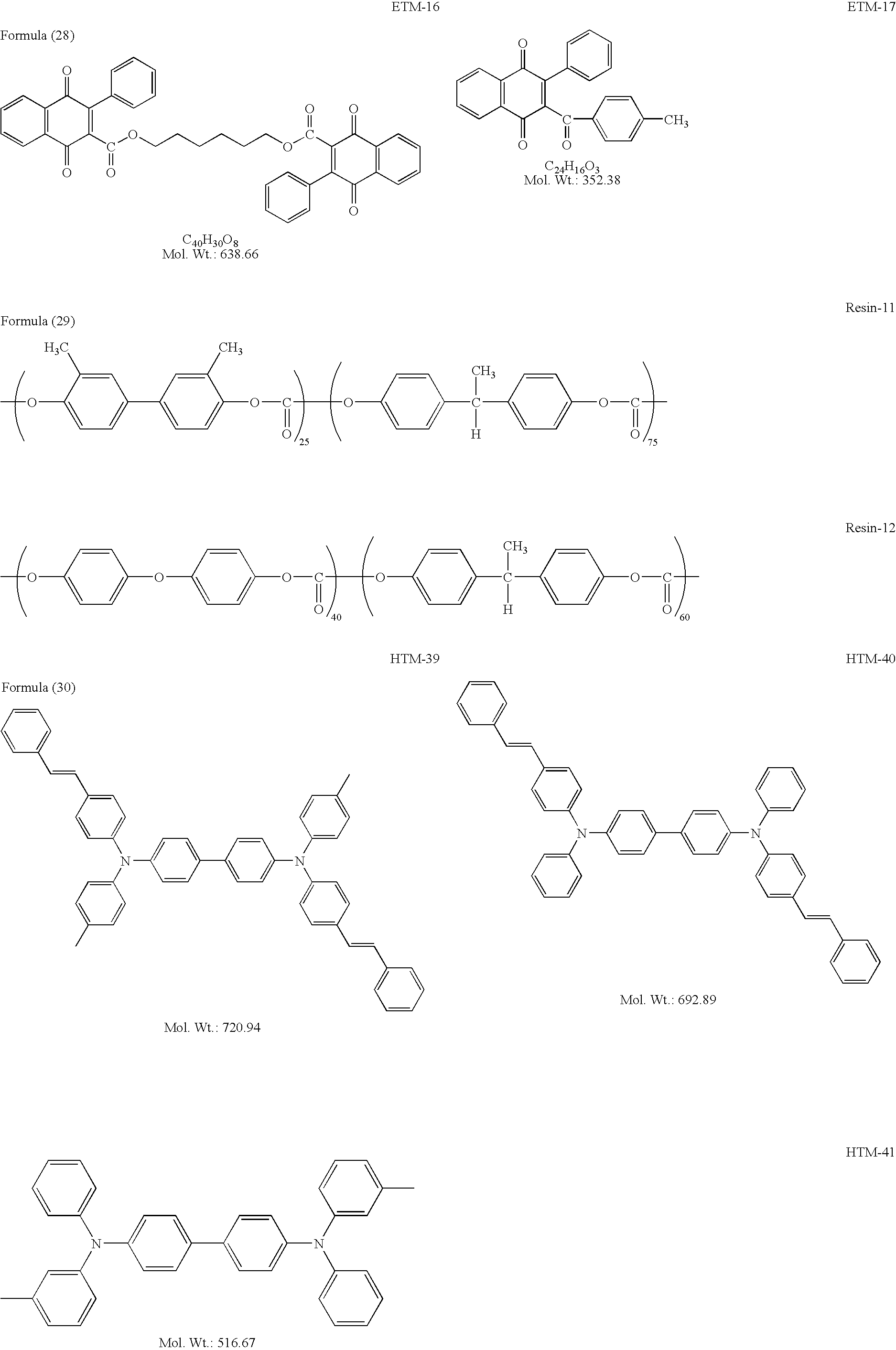

TABLE 6

| | | | Hole-transfer | | | | | Variation | |
|---|---|---|---|---|---|---|---|---|---|
| | | Charge- | agent | | Electron- | | Initial | in | |
| | Binder | generating | | Molecular | transfer | HTM | sensitivity | sensitivity | Change in |
| | resin | agent | Type | weight | agent | (g/m2) | (V) | (V) | appearance |
| Ex. 61 | Resin-1 | CGM-1 | HTM-5 | 929.2 | ETM-16 | 0.0081 | 110 | +1 | Excellent |
| Ex. 62 | | CGM-2 | | | | 0.0074 | 89 | +1 | Excellent |
| Ex. 63 | | CGM-3 | | | | 0.0081 | 95 | −1 | Excellent |
| Ex. 64 | | CGM-4 | | | | 0.0074 | 116 | −2 | Excellent |
| Ex. 65 | | CGM-1 | HTM-22 | 957.3 | | 0.0066 | 111 | +1 | Excellent |
| Ex. 66 | | | HTM-23 | 973.3 | | 0.0059 | 105 | +2 | Excellent |
| Ex. 67 | | | HTM-24 | 981.3 | | 0.0055 | 111 | +4 | Excellent |
| Ex. 68 | Resin- | | HTM-5 | 929.2 | | 0.0089 | 112 | +2 | Excellent |
| | 11 | | | | | | | | |
| Ex. 69 | Resin-3 | | | | | 0.0074 | 114 | +1 | Excellent |
| Ex. 70 | Resin- | | | | | 0.0066 | 112 | +1 | Excellent |
| | 12 | | | | | | | | |
| Ex. 71 | Resin-1 | | | | ETM-12 | 0.0136 | 117 | +2 | Excellent |
| Ex. 72 | | | | | ETM-17 | 0.0168 | 118 | +2 | Good |
| Ex. 73 | | | | | ETM-13 | 0.0096 | 109 | +1 | Excellent |
| Ex. 74 | | | | | ETM-2 | 0.0076 | 105 | 0 | Excellent |
| Ex. 75 | | | | | ETM-14 | 0.0191 | 123 | +3 | Good |
| C.E. 19 | | | HTM-39 | 516.7 | ETM-16 | 0.0539 | 142 | +22 | Very poor |
| C.E. 20 | | | HTM-37 | 451.6 | | 0.0639 | 115 | +45 | Very poor |
| C.E. 21 | Resin-5 | | | | | 0.9685 | 114 | +675 | Very poor |

*HTM: the amount of the elution of the hole-transfer agent.
Ex.: Example
C.E.: Comparative Example

### INDUSTRIAL APPLICABILITY

As described in detail above, according to the present invention, by limiting the amount of elution of a hole-transfer agent or the amount of an electron-transfer agent after immersing in certain paraffin solvent under predetermined conditions, an electrophotographic photoconductor for wet developing having a photoconductor improved in not only solvent resistance but also variations in sensitivity and variations in repeat characteristics even after long-term usage, and an image-forming apparatus equipped with such an electrophotographic photoconductor for wet developing have been obtained.

Thus, the electrophotographic photoconductor for wet developing of the present invention is expected to contribute to cost reduction, speed enhancement, higher performance and so on in a variety of image-forming apparatuses such as copiers or printers.

What is claims:

1. An electrophotographic photoconductor for wet developing having a photoconductive layer containing at least a binder resin, a charge-generating agent, a hole-transfer agent and an electron-transfer agent,
wherein an amount of elution of the hole-transfer agent after 2,000-hour-immersion in paraffin solvent having a kinematic viscosity (25° C., in accordance with ASTM D445) of 1.4 to 1.8 mm²/s is 0.040 g/m² or less.

2. The electrophotographic photoconductor for wet developing according to claim 1, wherein the amount of the elution of the hole-transfer agent after 200-hour-immersion in the paraffin solvent is 0.018 g/m² or less.

3. The electrophotographic photoconductor for wet developing according to claim 1, wherein the amount of addition of the hole-transfer agent is in the range of 10 to 80 parts by weight with respect to 100 parts by weight of the binder resin.

4. The electrophotographic photoconductor for wet developing according to claim 1, wherein a molecular weight of the hole-transfer agent is 900 or more.

5. The electrophotographic photoconductor for wet developing according to claim 1, wherein the hole-transfer agent has a stilbene structure represented by a following general formula (1): 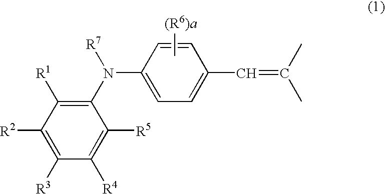
(wherein each of R¹ to R⁷ independently represents a hydrogen atom, a halogen atom, a substituted or unsubstituted alkyl group having 1 to 20 carbon atoms, a substituted or unsubstituted alkenyl group having 2 to 20 carbon atoms, a substituted or unsubstituted aryl group having 6 to 30 carbon atoms, a substituted or unsubstituted aralkyl group having 6 to 30 carbon atoms, a substituted or unsubstituted azo group or a substituted or unsubstituted diazo group having 6 to 30 carbon atoms, and the number of repetitions “a” is an integer of 1 to 4.)

6. The electrophotographic photoconductor for wet developing according to claim 1, wherein the amount of the addition of the electron-transfer agent is in the range of 10 to 100 parts by weight with respect to 100 parts by weight of the binder resin.

7. The electrophotographic photoconductor for wet developing according to claim 1, wherein the molecular weight of the electron-transfer agent is 600 or more.

8. The electrophotographic photoconductor for wet developing according to claim 1, wherein the photoconductive layer is a mono-layered type containing at least the charge-generating agent, the hole-transfer agent, the electron-transfer agent and the binder resin in the same layer on a conductive substrate.

9. An image-forming apparatus for wet developing equipped with an electrophotographic photoconductor for wet developing, containing at least a binder resin, a charge-generating agent, a hole-transfer agent and an electron-transfer agent,
wherein an amount of elution of the hole-transfer agent after 2,000-hour-immersion in paraffin solvent having a kinematic viscosity (25° C., in accordance with ASTM D445) of 1.4 to 1.8 mm²/s is 0.040 g/m² or less,
and a developer containing, as a liquid carrier, a paraffin solvent having a kinematic viscosity (25° C., in accordance with ASTM D445) of 1.4 to 1.8 mm²/s is used.

10. The image-forming apparatus for wet developing according to claim 9, wherein a content of an aromatic component in the paraffin solvent is 0.05% by weight or less with respect to a total amount thereof.

11. An electrophotographic photoconductor for wet developing having a photoconductive layer containing at least a binder resin, a charge-generating agent, a hole-transfer agent and an electron-transfer agent,
wherein an amount of elution of the electron-transfer agent after 2,000-hour-immersion in a paraffin solvent having a kinematic viscosity (25° C., in accordance with ASTM D445) of 1.4 to 1.8 mm²/s is 0.12 g/m² or less.

12. The electrophotographic photoconductor for wet developing according to claim 11, wherein the amount of the elution of the electron-transfer agent after 200-hour-immersion in the paraffin solvent is 0.03 g/m² or less.
